(19) United States
(12) Patent Application Publication
(10) Pub. No.: US 2025/0126651 A1
(43) Pub. Date: Apr. 17, 2025

(54) SYSTEM INFORMATION FOR ASSISTED ACCESS IN WIRELESS COMMUNICATIONS

(71) Applicant: QUALCOMM Incorporated, San Diego, CA (US)

(72) Inventors: Aria HASANZADEZONUZY, Somerville, NJ (US); Kianoush HOSSEINI, San Diego, CA (US); Tao LUO, San Diego, CA (US)

(21) Appl. No.: 18/487,859

(22) Filed: Oct. 16, 2023

(51) Int. Cl. H04W 74/08; H04W 52/02; H04W 76/10

(52) U.S. Cl. CPC H04W 74/0833; H04W 52/0235; H04W 76/10

(57) ABSTRACT

Methods, systems, and devices for wireless communications are described. A user equipment (UE) may receive a broadcast system information (SI) message from a first cell, wherein the broadcast SI message includes SI for connecting to a second cell. The broadcast SI message may include a synchronization signal block (SSB) message, a system information block (SIB) message, a master information block (MIB) message, or any combination thereof. The UE may then transmit a random access channel (RACH) message to the first cell or the second cell based on receiving the SI included within the broadcast SI message, and perform a random access procedure with the second cell to establish a wireless connection with the second cell based on transmitting the RACH message. Subsequently, the UE may communicate one or more messages with the second cell based on the random access procedure.

### FIELD OF TECHNOLOGY

The following relates to wireless communications, including system information for assisted access in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

As future generations of radio access technologies (RATs) are developed and deployed, many wireless networks will support multiple RATs during a “migration period.” For example, wireless networks will support both 5G and Sixth Generation (6G) devices as wireless devices are gradually “migrated” to 6G devices. However, there are several challenges when handling migrations across RATs.

### SUMMARY

The described techniques relate to improved methods, systems, devices, and apparatuses that support system information for assisted access in wireless communications. Generally, aspects of the present disclosure are directed to signaling that is used to facilitate connections between wireless devices and network cells, and to facilitate network migration between/across radio access technologies (RATs) (e.g., migration from Fifth Generation (5G) communications to Sixth Generation (6G) communications). In particular, aspects of the present disclosure enable a source cell (e.g., 5G cell) to include system information (SI) used for connecting with a target cell (e.g., 6G cell) within SI broadcast by the source cell. By including such SI within broadcast SI messages (e.g., master information blocks (MIBs), system information blocks (SIBs), synchronization signal blocks (SSBs)), techniques described herein may reduce unnecessary signaling performed by the target cell, and prevent wireless devices from having to establish a full connection with the source cell in order to communicate with the target cell.

### BRIEF DESCRIPTION OF THE DRAWINGS

FIG. 1 shows an example of a wireless communications system that supports system information for assisted access in wireless communications in accordance with one or more aspects of the present disclosure.

FIG. 2 shows an example of a wireless communications system that supports system information for assisted access in wireless communications in accordance with one or more aspects of the present disclosure.

FIG. 3 shows an example of a process flow that supports system information for assisted access in wireless communications in accordance with one or more aspects of the present disclosure.

FIG. 4 shows an example of a process flow that supports system information for assisted access in wireless communications in accordance with one or more aspects of the present disclosure.

FIGS. 5 and 6 show block diagrams of devices that support system information for assisted access in wireless communications in accordance with one or more aspects of the present disclosure.

FIG. 7 shows a block diagram of a communications manager that supports system information for assisted access in wireless communications in accordance with one or more aspects of the present disclosure.

FIG. 8 shows a diagram of a system including a device that supports system information for assisted access in wireless communications in accordance with one or more aspects of the present disclosure.

FIGS. 9 and 10 show block diagrams of devices that support system information for assisted access in wireless communications in accordance with one or more aspects of the present disclosure.

FIG. 11 shows a block diagram of a communications manager that supports system information for assisted access in wireless communications in accordance with one or more aspects of the present disclosure.

FIG. 12 shows a diagram of a system including a device that supports system information for assisted access in wireless communications in accordance with one or more aspects of the present disclosure.

FIGS. 13 through 15 show flowcharts illustrating methods that support system information for assisted access in wireless communications in accordance with one or more aspects of the present disclosure.

### DETAILED DESCRIPTION

As future generations of radio access technologies (RATs) are developed and deployed, many wireless networks will support multiple RATs during a “migration period.” For example, wireless networks will support both Fifth Generation (5G) and Sixth Generation (6G) devices as wireless devices are gradually “migrated” to 6G devices. However, there are several challenges when handling migrations across RATs. First, power consumption and network energy savings (NES) issues may arise when supporting multiple RATs within a network. For example, there may be cases where a 6G cell does not actually include any 6G devices. In such cases, energy used by the 6G cell to broadcast information for 6G cells may be wasted. Secondly, previous migration techniques (such as migration techniques used for the 4G to 5G/LTE migration) may require devices to first establish a connection with the older “legacy” RAT so that the legacy RAT can facilitate a connection to the newer RAT. However, requiring devices to establish connections with legacy RATs in order to communicate via newer RATs may lead to increased control signaling overhead and network congestion.

Accordingly, aspects of the present disclosure are directed to signaling that is used to facilitate connections between wireless devices and network cells, and to facilitate network migration between/across RATs (e.g., migration from Fifth Generation (5G) communications to Sixth Generation (6G) communications). In particular, aspects of the present disclosure enable a source cell (e.g., 5G cell) to include system information (SI) used for connecting with a target cell (e.g., 6G cell) within SI broadcast by the source cell. By including such SI within broadcast SI messages (e.g., master information blocks (MIBs), system information blocks (SIBs), synchronization signal blocks (SSBs)), techniques described herein may reduce unnecessary signaling performed by the target cell, and prevent wireless devices from having to establish a full connection with the source cell in order to communicate with the target cell.

For example, a UE may receive a broadcast SI message (e.g., SIB, MIB, SSB) from a first cell, such as a 5G cell. The broadcast SI message may include SI that is usable for communicating with a second cell, such as a 6G cell. Subsequently, and using the received SI, the UE may transmit a random access channel (RACH) message in order to establish a connection with the second cell. The UE may transmit the RACH message directly to the second cell, or may transmit the RACH message to the first cell, where the first cell relays the RACH message to the second cell. In some cases, the RACH message may “wake-up” the second cell so that the UE and the second cell can perform a RACH procedure and begin communicating with one another.

In this example, including the SI within the broadcast SI message transmitted by the source cell may reduce or eliminate the need for the target cell (e.g., 6G cell) to broadcast SI, thereby reducing network power consumption at the target cell and allowing the target cell to remain within a low-power state (e.g., sleep state) until devices attempt to connect with the target cell. Further, by including the SI within the broadcast SI message, the UE may not be required to establish a full connection with the source cell in order to receive the SI and connect with the target cell, thereby reducing control signaling overhead within the network. Rather, the UE can simply monitor for the broadcast SI message within resources that are pre-configured by the network without performing a full RACH procedure with the source cell.

Aspects of the disclosure are initially described in the context of wireless communications systems. Additional aspects of the disclosure are described in the context of example process flows. Aspects of the disclosure are further illustrated by and described with reference to apparatus diagrams, system diagrams, and flowcharts that relate to system information for assisted access in wireless communications.

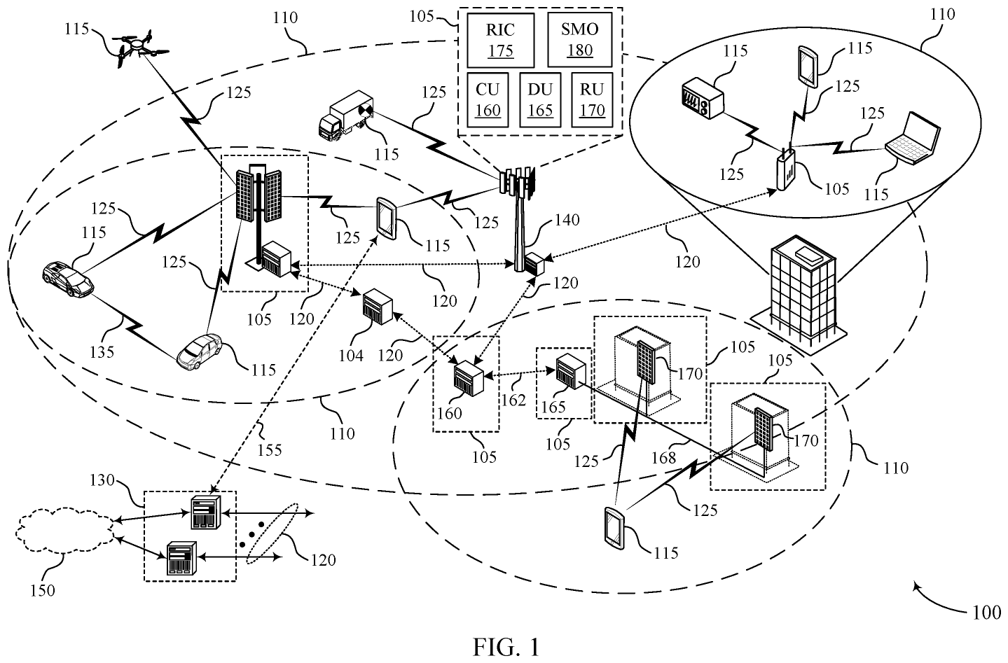

FIG. 1 shows an example of a wireless communications system 100 that supports system information for assisted access in wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support system information for assisted access in wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A. LTE-A Pro, NR). Each physical layer channel may carry acquisition signaling (e.g., synchronization signals, SI), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UEs 115 and the network entities 105 of the wireless communications system 100 may be configured to support signaling that is used to facilitate connections between wireless devices and network cells, and to facilitate network migration between RATs (e.g., 5G to 6G migration). In particular, aspects of the present disclosure enable a source cell (e.g., 5G cell) to include SI used for connecting with a target cell (e.g., 6G cell) within SI broadcast by the source cell. By including such SI within broadcast SI messages (e.g., MIBs, SIBs, SSBs), techniques described herein may reduce unnecessary signaling performed by the target cell, and prevent wireless devices from having to establish a full connection with the source cell in order to communicate with the target cell.

For example, a UE 115 of the wireless communications system 100 may receive a broadcast SI message (e.g., SIB, MIB, SSB) from a first cell supported by the wireless communications system 100, such as a 5G cell. The broadcast SI message may include SI that is usable for communicating with a second cell, such as a 6G cell. Subsequently, and using the received SI, the UE 115 may transmit a RACH message in order to establish a connection with the second cell. The UE 115 may transmit the RACH message directly to the second cell, or may transmit the RACH message to the first cell, where the first cell relays the RACH message to the second cell. In some cases, the RACH message may “wake-up” the second cell so that the UE 15 and the second cell can perform a RACH procedure and begin communicating with one another.

In this example, including the SI within the broadcast SI message transmitted by the source cell may reduce or eliminate the need for the target cell (e.g., 6G cell) to broadcast SI, thereby reducing network power consumption at the target cell and allowing the target cell to remain within a low-power state (e.g., sleep state) until devices attempt to connect with the target cell. Further, by including the SI within the broadcast SI message, the UE may not be required to establish a full connection with the source cell in order to receive the SI and connect with the target cell, thereby reducing control signaling overhead within the network. Rather, the UE can simply monitor for the broadcast SI message within resources that are pre-configured by the network without performing a full RACH procedure with the source cell.

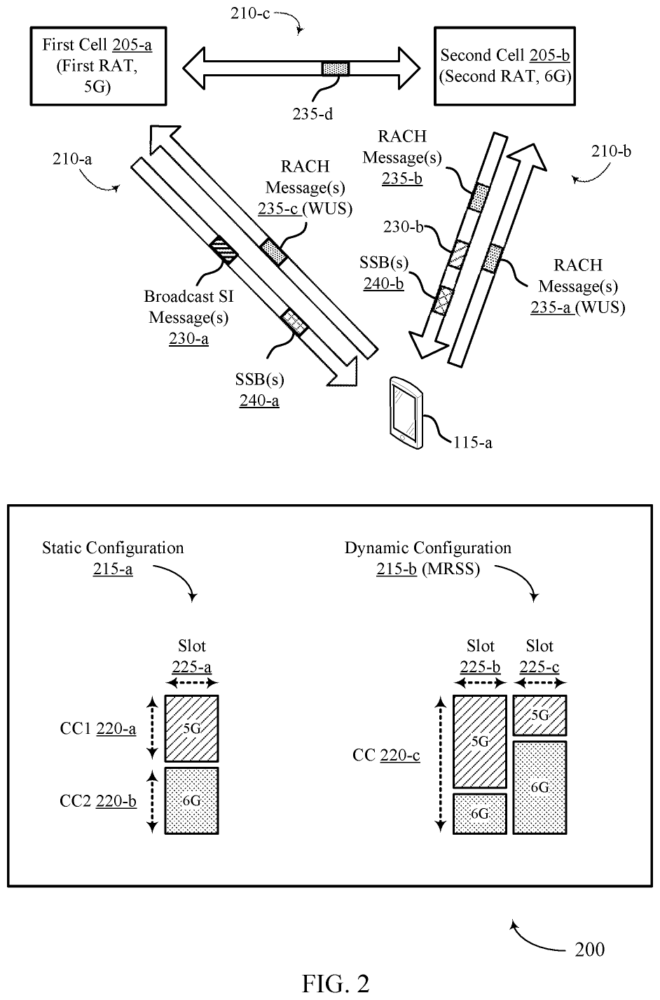

FIG. 2 shows an example of a wireless communications system 200 that supports system information for assisted access in wireless communications in accordance with one or more aspects of the present disclosure. Aspects of the wireless communications system 200 may implement, or be implemented by, aspects of the wireless communications system 100. For example, the wireless communications system 200 may support signaling and configurations for inter-RAT access, such as signaling used to facilitate inter-RAT migrations.

The wireless communications system 200 may include a UE 115-a, a first serving cell 205-a (e.g., source cell), and a second serving cell 205-b (e.g., target cell), which may be examples of UEs 115, network entities 105, and other wireless devices as described with reference to FIG. 1. In some cases, the serving cells 205 may be associated with (e.g., supported by) one or more network entities 105. For example, in some cases, the first serving cell 205-a and the second serving cell 205-b may be associated with (e.g., supported by) the same network entity 105. In such cases, the serving cells 205 may be said to be collocated (e.g., located in the same geographical position, and/or associated with the same hardware, circuitry, and/or RF components). By way of another example, in other cases, the first serving cell 205-a may be associated with a first network entity 105, and the second serving cell 205-b may be associated with a second network entity 105.

The serving cells 205-a, 205-b may be associated with the same or different radio access technologies RATs (e.g., 3G, 4G, LTE, 5G, NR, 6G, etc.), and may be configured to communicate within the same or different frequency bands. For example, in some cases, as shown in FIG. 2, the first serving cell 205-a may be associated with a 5G or NR RAT, and the second serving cell 205-b may be associated with a 6G RAT.

In some aspects, the UE 115-a may communicate with the serving cells 205 via communication links 210-a, 210-b. In some cases, the communication links 210 may include examples of access links (e.g., Uu links). The communication links 210 may include bi-directional links that can include both uplink and downlink communication. For example, the UE 115-a may transmit uplink transmissions, such as uplink control signals or uplink data signals, to the first serving cell 205-a using the communication link 210-a, and the first serving cell 205-a may transmit downlink transmissions, such as downlink control signals or downlink data signals, to the UE 115-a using the communication link 210-a. Similarly, the first serving cell 205-a and the second serving cell 205-b may communicate with one another via a communication link 210-c, which may be an example of an Xn interface.

In this regard, the wireless communications system 200 may be configured to support multiple RATs, including current and future RATs. As future generations of RATs are developed and deployed, the wireless communications system 200 may undergo a “migration period” during which both old (e.g., “legacy”) and new RATs are supported. For example, in the context of 5G and 6G communications, the wireless communications system 200 may support both 5G and 6G devices as wireless devices are gradually “migrated” to 6G devices.

There are several different “migration schemes” that may be used for migrating between/across RATs. For example, FIG. 2 illustrates a static configuration 215-a and a dynamic configuration 215-b that may be implemented during the migration process of the wireless communications system 200. The configurations 215 illustrate two different implementations where different RATs (e.g., 5G and 6G) can coexist within the wireless communication system 200.

The static configuration 215-a illustrates a “static reframing” configuration in which resources are divided up statically across the supported RATs in the time and/or frequency domain. With static reframing (as illustrated via the static configuration 215-a), a network vendor may dedicate a whole component carrier (or other set of resources) to 6G communications, where there is no coexistence of multiple RATs within/across the resources. For instance, as shown in the static configuration 215-a, resources within a first component carrier 220-a (CC1) (and within a given slot 225-a) may be allocated to 5G communications, whereas resources within a second component carrier 220-b (CC2) may be allocated to 6G communications. The static configuration 215-a may be constant across slots 225 or sets of slots 225, or may change from slot to slot.

Comparatively, the dynamic configuration 215-b illustrates an example of dynamic multi-RAT spectrum sharing (MRSS). With dynamic MRSS, component carriers 220 may be dynamically shared between multiple RATs (e.g., 5G and 6G) in the time, frequency, and/or spatial domains. For instance, as shown in the dynamic configuration 215-b, resources within a component carrier 220-c may be divided up and allocated for both 5G and 6G communications. Moreover, the division/allocation of resources across RATs may change from slot to slot. For example, the component carrier 220-c may be divided up according to a first allocation scheme during a first slot 225-b, and may be divided up according to a second allocation scheme during a second slot 225-c.

There are advantages and disadvantages to both the static reframing (e.g., static configuration 215-a) and the dynamic MRSS (e.g., dynamic configuration 215-b) implementations. In particular, static refarming could help with boosting network power efficiency, thereby incentivizing operators to migrate to a new RAT. Comparatively, MRSS is expected to bring resource utilization benefit, with a power-aware design for future RATs (e.g., 6G).

In some cases, wireless communications systems (such as the wireless communications system 200) may follow different migration scenarios or migration paths that utilize combinations of the static reframing (e.g., static configuration 215-a) and the dynamic MRSS (e.g., dynamic configuration 215-b) implementations. For example, some wireless communications systems may utilize only the static configuration 215-a. In such cases, the network (e.g., network vendor) may reframe some serving cells 205 of the network to provide only 6G service. As such, the network may be made up of 5G-only cells and 6G-only cells.

In other cases, a network may include 5G-only cells, as well as 5G/6G MRSS cells. In other words, the network may implement a combination of the static configuration 215-a and the dynamic configuration 215-b to include some serving cells 205 that support only 5G communications, and some cells that support both 5G and 6G communications (e.g., MRSS cells). In other words, some of the serving cells 205 of a cell site may remain operating in 5G, while other cells would be shared with 6G RAT dynamically. In practice, it is unlikely that MRSS is enabled everywhere within a network at the same time. As such, since the process is gradual, the use of both the static configuration 215-a and the dynamic configuration 215-b for the migration process may allow for some serving cells 205 within the network to remain 5G cells for a longer duration.

Similarly, in other cases, a network may include 6G-only cells, as well as 5G/6G MRSS cells. In other words, the network may implement a combination of the static configuration 215-a and the dynamic configuration 215-b to include some serving cells 205 that support only 6G communications, and some cells that support both 5G and 6G communications (e.g., MRSS cells). In other words, under this implementation, some serving cells 205 may be reframed for 6G-only service, while other serving cells 205 would be shared between 5G and 6G RATs dynamically. As more devices within the network become 6G-capable, some of the MRSS serving cells 205 may be phased-out of 5G and converted to 6G-only cells (e.g., sunset 5G communications/cells as more devices become 6G-capable).

Lastly, in other implementations, a network may include all 5G/6G MRSS serving cells 205. That is, the network may designate all serving cells 205 in the network as dynamic MRCC cells that support both 5G and 5G communications. Over time, more and more serving cells 205 may support MRSS assuming that both 5G and 6G have comparable market penetration.

When considering which of the above migration scheme/implementations to use within a network, there are multiple aspects or parameters to consider, including the quantity of wireless devices (e.g., UEs 115) within the network that are capable of communicating within the respective RATs. Other parameters taken into consideration when determining which migration scheme to implement include collocation, frequency ranges of the different RATs, and network architecture. Collocation refers to whether or not different serving cells 205/network entities 105 are positioned in the same location (e.g., collocated). If two serving cells 205 are collocated, it may be assumed that communications between a UE 115-a and the collocated serving cells 205 experience (substantially) the same channel conditions, pathloss (PL), timing advance (TA) values, and the like. In other words, for collocated serving cells 205, the differences of TA values and PL across two cells may be assumed to be negligible. Further, collocation between serving cells 205 may be a factor when determining whether two serving cells 205 are coordinated, which is a key assumption for MRSS. Collocation is also important in the context of static reframing (e.g., static configuration 215-a), as will be described in further detail herein.

The frequency ranges between serving cells 205/RATs is another factor when determining which migration scheme to use. A gap in frequency refers to the distance (in the frequency domain) between the operating frequency ranges between two serving cells 205. Gaps in frequency between two serving cells 205 is important for assistant mode of operation where the serving cells 205 are going to “cooperate” with one another, as will be described in further detail herein.

Lastly, network architecture is another factor when determining which migration scheme to use. The term “network architecture” may be used to refer to the circuitry and RF architecture of respective serving cells 205. In particular, network architecture determines whether or not the serving cells 205 share the same antenna elements and/or RF chains, which can lead to different migration solutions and power consumption conclusions.

As noted previously herein, there are several challenges when handling migrations across RATs. First, power consumption and network energy savings (NES) issues may arise when supporting multiple RATs within a network. NES is one of the important aspects of 6G network design. One of the energy-consuming procedures within the network results from cells/network entities 105 transmitting broadcast signals for accessing the network. For example, in a 5G network, a cell 205/network entity 105 may transmit/broadcast a burst of SSBs and SIBs to wireless devices within the network, where the cell 205/network entity 105 subsequently monitors for responsive uplink transmissions (e.g., monitors for approximately 4 milliseconds (ms) every 20 ms) from the wireless devices attempting to access the network. The total duration of the SSB/SIB bursts may depend on communications parameters used by the respective cell 205/network entity 105, such as the number of beams, remaining minimum SI (RMSI) multiplexing patterns, and a RACH Occasion (RO) configuration.

In some cases, each respective serving cell 205 (and/or each respective RAT) may broadcast its own SI to allow wireless devices to connect with the respective cell 205/RAT. However, this may result in increased power consumption and/or wasted resources. For example, there may be cases where a 6G cell (e.g., second serving cell 205-b) does not actually include wireless devices capable of 6G communications. In such cases, energy used by the 6G cell (e.g., second serving cell 205-b) to broadcast SI for 6G cells may be wasted.

Accordingly, aspects of the present disclosure are directed to techniques which utilize signaling used by 5G cells may be used to facilitate connections between 6G cells and wireless devices. This assistance provided by 5G cells could result in reduced transmission of 6G broadcast communications (e.g., broadcast SI), hence reduction in network energy consumption. In other words, aspects of the present disclosure are directed to signaling performed by the first serving cell 205-a (e.g., 5G cell) to facilitate a connection between the second serving cell 205-b (e.g., 6G cell) and the UE 115-a.

While much of the present disclosure is described in the context of signaling used to facilitate communications between serving cells 205 associated with different RATs (e.g., inter-RAT cases), this is not to be regarded as a limitation of the present disclosure, unless noted otherwise herein. In particular, aspects of the present disclosure may be used in the context of intra-RAT cases, such as between two 5G serving cells 205, between two 6G serving cells 205, and the like. For example, in some cases, both the serving cells 205-a, 205-b illustrated in FIG. 2 may include 5G cells. In such cases, aspects of the present disclosure may be implemented to utilize signaling from the first serving cell 205-a (e.g., first 5G cell) to facilitate a connection between the second serving cell 205-b (e.g., second 5G cell) and the UE 115-a.

Another issue associated with some previous migration techniques (such as migration techniques used for the 4G to 5G/LTE migration) is that devices may be required to first establish a connection with the older “legacy” RAT so that the legacy RAT can facilitate a connection to the newer RAT. However, requiring devices to establish connections with legacy RATs in order to communicate via newer RATs may lead to increased control signaling overhead and network congestion.

For example, in the context of some previous migration techniques, the UE 115-a may be required to connect to (e.g., perform a RACH procedure and establish an RRC connection with) the first serving cell 205-a (e.g., 5G cell), where the second serving cell 205-b (e.g., 6G cell) is then waken up and aggregated by the UE 115-a as either a secondary cell (SCell) or a secondary cell group (SCG). However, in cases where the UE 115-a is a 6G-capable device, the control signaling used to establish the connection with the 5G cell may be unnecessary and lead to increased network congestion (as well as delay connection between the UE 115-a and the 6G cell).

By way of another example, according to some previous migration techniques, the UE 115-a may be required to connect to (e.g., perform a RACH procedure and establish an RRC connection with) the first serving cell 205-a (e.g., 5G cell), where the first serving cell 205-a (e.g., 5G cell) subsequently wakes up the second serving cell 205-b (e.g., 6G cell) and directs the UE 115-a to move to the second serving cell 205-b via a handover procedure. As noted elsewhere, requiring the UE 115-a to establish a connection with the 5G cell may be unnecessary and lead to increased network congestion. Moreover, handover procedures may take a long time to complete, further delaying communications between the UE 115-a and the second serving cell 205-b.

Accordingly, in order to address some of the issues associated with prior migration techniques, aspects of the present disclosure are directed to signaling and techniques that enable the UE 115-a to utilize signaling from the first serving cell 205-a (e.g., 5G cell) to establish a connection with the second serving cell 205-b (e.g., 6G cell) without ever fully establishing a connection with the first serving cell 205-a.

In other words, aspects of the present disclosure enable the UE 115-a to utilize signaling from a 5G cell to establish a connection with a 6G cell without ever performing a RACH procedure or establishing an RRC connection with the 5G cell. In this regard, aspects of the present disclosure utilize signaling from the first serving cell 205-a to facilitate connections with the second serving cell 205-b without utilizing handover procedures and/or without considering mRAT carrier aggregation or 5G-6G dual connectivity with a 5G master cell group (MCG). That is, an objective of the present disclosure is to enable 6G-capable UEs 115 to access 6G cells without ever connecting to a 5G cell, but nonetheless receiving assistance from a 5G cell.

In some aspects, signaling from the first serving cell 205-a may be used to facilitate a connection between the UE 115-a and the second serving cell 205-b using a one-step SI acquisition approach, and a two-step SI acquisition approach. At a high level, in accordance with the one-step SI acquisition approach, broadcast SI message(s) 230-a received from the first serving cell 205-a may include all the SI required for the UE 115-a to perform a RACH procedure and establish a connection with the second serving cell 205-b. Comparatively, in accordance with the two-step SI acquisition approach, broadcast SI message(s) 230-a received from the first serving cell 205-a may include some of the SI required for the UE 115-a to transmit a RACH message and/or wake-up signal (WUS) to wake up the second serving cell 205-b, where additional broadcast SI messages 230-b received from the second serving cell 205-b include the remaining SI required for the UE 115-a to perform a RACH procedure and establish a connection with the second serving cell 205-b.

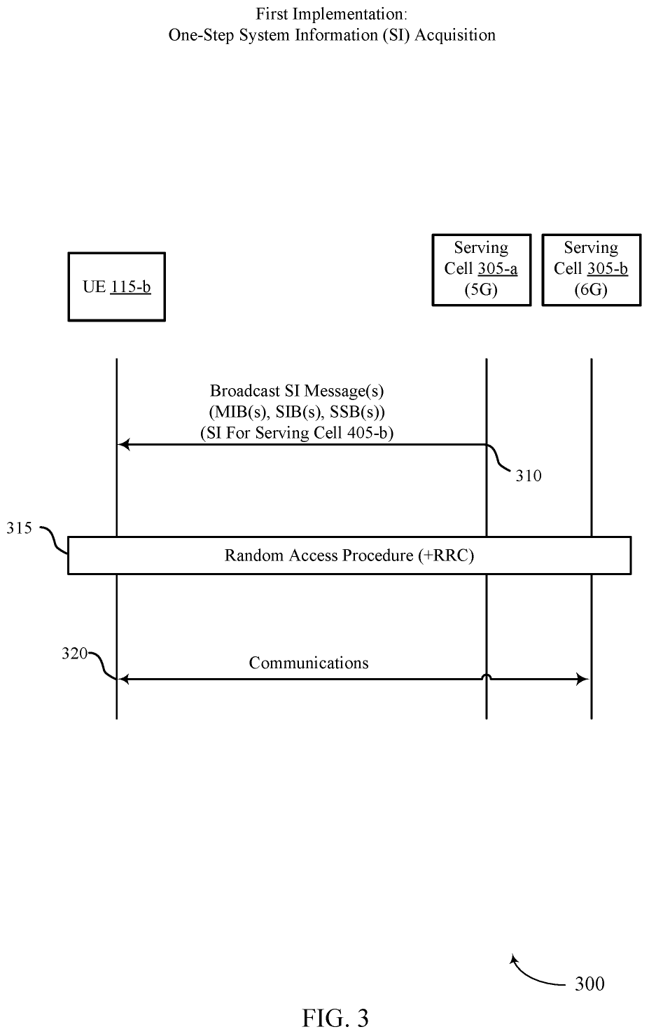

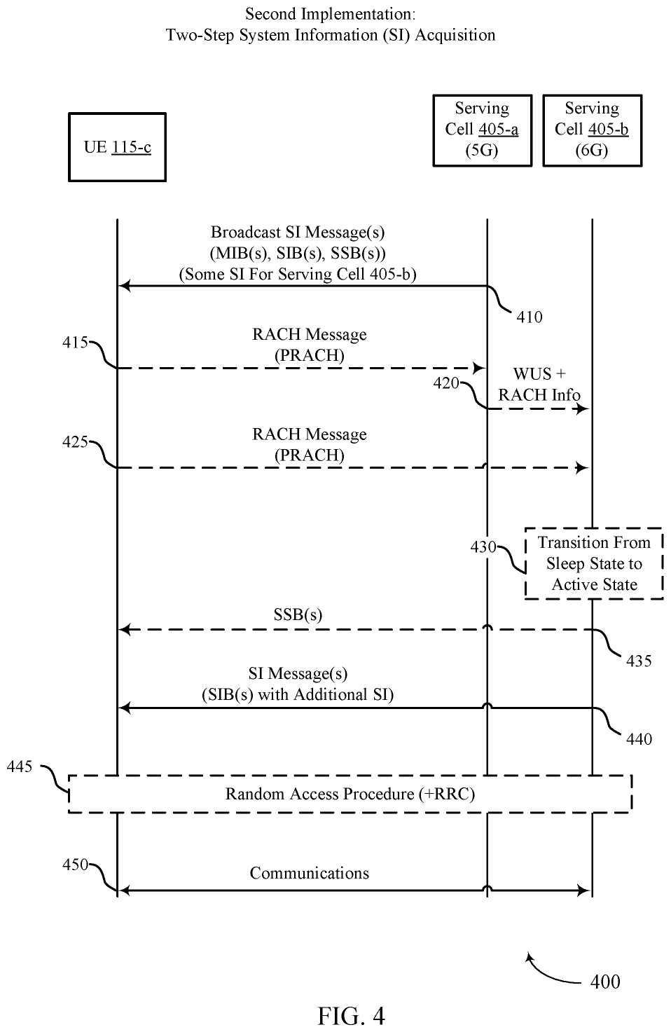

Each of the one-step SI acquisition approach and the two-step SI acquisition approach will be described in further detail herein with reference to FIG. 2. Moreover, the one-step SI acquisition approach is further shown and described with reference to FIG. 3, and the two-step SI acquisition approach is further shown and described with reference to FIG. 4.

In accordance with the one-step SI acquisition approach, the UE 115-a (e.g., 6G-capable UE 115-a) may be assisted via the first serving cell 205-a (e.g., 5G cell) to access the second serving cell 205-b (e.g., 6G cell). To do so, the first serving cell 205-a may transmit/broadcast 6G-related information via broadcast communications. For example, the first serving cell 205-a may transmit (e.g., broadcast) SI messages 230-a. The broadcast SI messages 230-a may include MIBs, SIBs (e.g., SIB1s), SSBs, or any combination thereof. The first serving cell 205-a may transmit the broadcast SI messages 230-a using 5G signaling (e.g., within 5G resources, using 5G communication protocols).

In such cases, the broadcast SI messages 230-a (e.g., 5G SIBs) may be extended or modified (e.g., new SIB formats) to carry additional 6G-related information. In other words, the 5G broadcast SI messages 230-a may include one or more bit fields used to communicate 6G-related SI that is usable by the UE 115-a for accessing the second serving cell 205-b. In some aspects, UEs 115 that are only capable of 5G communications may be configured to ignore the bit fields associated with the 6G-related SI. Moreover, in cases where new SIB formats are used for the broadcast SI messages 230-a that communicate 6G-related SI, 5G-capable UEs 115 (e.g., UEs 115 that are not capable of performing 6G communications) may ignore or otherwise refrain from reading the new SIB formats (e.g., refrain from decoding or processing the SIB formats with 6G-related SI).

In some aspects, spare and/or additional reserved bits in MIBs and physical broadcast channel (PBCH) of 5G SSBs (e.g., broadcast SI messages 230-a) may indicate whether 6G service is being offered or not. That is, unused or new bits within the broadcast SI messages 230-a may indicate whether there are 6G cells accessible within the network or surrounding geographical area. Thus, previously unused or new bit fields within the broadcast SI messages 230-a may indicate whether or not the broadcast SI messages 230-a include SI for accessing such 6G cells.

In some aspects, bit fields within the broadcast SI message(s) 230-a may be used to indicate whether or not 6G service is being offered, such as via bit fields within extended SIBs. In such cases, the UE 115-a may be able to determine (in advance) whether 6G service is even offered so that it can make an informed decision as to whether or not to attempt to connect to a 6G cell. In cases where this information is included within extended SIBs, the UE 115-a may be required to decode the SIBs, which may result in higher UE power consumption.

Additionally, or alternatively, bit fields within the broadcast SI messages 230-a may be used to indicate whether the 6G cell (e.g., second serving cell 205-b) is MRSSed with the 5G cell (e.g., first serving cell 205-a), or whether the 5G cell is assisting access to a reframed 6G cell. In other words, bit fields within the broadcast SI messages 230-a may indicate whether resources associated with the second serving cell 205-b (e.g., 6G cell) are allocated according to the static configuration 215-a (e.g., static reframing) or the dynamic configuration 215-b (e.g., MRSS). For example, the first serving cell 205-a may set a spare bit within the broadcast SI message 230-a to “0” to indicate that the 5G cell (e.g., first serving cell 205-a) is not associated with any 6G cell or 6G service. Conversely, the first serving cell 205-a may set the spare bit to “1” and may set one or more additional bits to “0” to indicate that the 5G cell (e.g., first serving cell 205-a) is MRSSed with a 6G cell (e.g., second serving cell 205-b). Similarly, the first serving cell 205-a may set the spare bit to “1” and may set one or more additional bits to “1” to indicate that the 5G cell (e.g., first serving cell 205-a) is associated with a reframed 6G cell (e.g., second serving cell 205-b), where the SI for the 6G cell is indicated on the (extended) 5G SIBs (e.g., broadcast SI messages 230-a).

In some cases, the first serving cell 205-a may be configured to transmit/broadcast the SI messages 230-a that include the SI for accessing the second serving cell 205-b on pre-defined or pre-configured resources. In other words, the resources used by the first serving cell 205-a may be pre-configured and/or hardcoded into the UE 115-a so that the UE 115-a is be able to monitor for and receive the broadcast SI messages 230-a from the first serving cell 205-a without ever establishing a connection with the first serving cell 205-a. That is, the UE 115-a may be able to receive the broadcast SI messages 230-a via 5G signaling without ever actually performing a RACH procedure with (or establishing an RRC connection with) the first serving cell 205-a (e.g., 5G cell).

The broadcast SI messages 230-a may include SI associated with the second serving cell 205-b (e.g., 6G-related SI). The SI included within the broadcast SI messages 230-a may be usable by the UE 115-a to access the second serving cell 205-b. The SI may include RACH configuration information, (e.g., RACH sequences, RACH occasions (ROs), resources of ROs in the time/frequency domains, random access response (RAR) search space configuration, etc.), resources for communicating with the second serving cell 205-b (e.g., uplink bandwidth parts (BWPs) and/or downlink BWPs for communicating with the second serving cell 205-b), a control resource set (CORESET) associated with the second serving cell 205-b, and the like. In this regard, in accordance with the one-step SI acquisition approach, the broadcast SI messages 230-a received from the first serving cell 205-a may include all the SI required by the UE 115-a to perform a RACH procedure and access the second serving cell 205-b.

As such, in accordance with the one-step SI acquisition approach, the UE 115-a may perform a RACH procedure with the second serving cell 205-b (e.g., 6G cell) based on (e.g., in accordance with) the SI received via the first serving cell 205-a. That is, after obtaining the SI from the first serving cell 205-a (e.g., ROs, initial DL/UL BWP, etc.), the UE 115-a may be configured to initiate and continue an initial access procedure with the second serving cell 205-b (e.g., perform a RACH procedure and RRC connection procedure on 6G carriers/frequencies). That is, the UE 115-a may utilize the SI received from the first serving cell 205-a (via the broadcast SI messages 230-a) to exchange RACH messages 235-a, 235-b (e.g., physical RACH (PRACH) messages) with the second serving cell 205-b as part of a RACH procedure. In some cases, the UE 115-a may transmit RACH messages 235-a that include a WUS for the second serving cell 205-b to transition from a sleep state to an active state in order to perform the RACH procedure.

In some cases, such as in cases where the serving cells 205 are collocated, the UE 115-a may utilize spatial information. TA values, pathloss information, and other information determined based on measurements performed on SSBs 240-a received from the first serving cell 205-a to communicate with the second serving cell 205-b. That is, when the cells are collocated, the UE 115-a may assume that measurements/determinations performed on the SSBs 240-a received from the first serving cell 205-a also apply to the second serving cell 205-b.

In the context of the one-step SI acquisition approach, because the broadcast SI messages 230-a from the first serving cell 205-a included all the SI required to access the second serving cell 205-b, the second serving cell 205-b (e.g., 6G cell) may not be required or expected to periodically send SSBs, SIBs, and/or other broadcast SI messages 230. As such, the one-step SI acquisition approach may enable the second serving cell 205-b to reduce (or eliminate) energy consumption used to transmit/broadcast SI messages 230-b, thereby reducing energy consumption within the network. Further, enabling the second serving cell 205-b to refrain from broadcasting SI messages 230-b may enable the second serving cell 205-b to remain in a sleep state for longer periods of time, thereby further decreasing the energy consumption at the second serving cell 205-b.

As described herein, new and/or extended SIB formats may be used for the broadcast SI messages 230-a in the context of the one-step SI acquisition approach in order to communicate the SI associated with the second serving cell 205-b. The use of extended SIB formats (and/or new SIB formats with additional bit fields) may lead to higher signaling overhead on 5G cell for the periodic transmission of the broadcast SI messages 230-a. While this leads to reduced power consumption at the second serving cell 205-b (as it reduces/eliminates the need for the second serving cell 205-b to broadcast SI messages 230-b), this may result in lower resource utilization and higher network power consumption on 5G cell.

Accordingly, in accordance with the two-step SI acquisition approach, signaling from both the first serving cell 205-a (e.g., 5G cell) and the second serving cell 205-b (e.g., 6G cell) may be used to communicate SI that is used to access the second serving cell 205-b. That is, instead of the first serving cell 205-a communicating all the SI required to access the second serving cell 205-b, the SI may be divided up across broadcast SI messages 230 received from both serving cells 205. By using broadcast SI messages 230-b from the second serving cell 205-b to communicate some SI used to access the second serving cell 205-b, the two-step SI acquisition approach may be used to reduce power consumption at the 5G cell.

For example, in accordance with the two-step SI acquisition approach, the UE 115-a may receive broadcast SI messages 230-a from the first serving cell 205-a, as described previously herein. As compared to the one-step SI acquisition approach in which the broadcast SI messages 230-a included all the SI required for the UE 115-a to access the second serving cell 205-b, in accordance with the two-step SI acquisition approach, the broadcast SI messages 230-a may include only a subset of SI that enables the UE 115-a to initiate a RACH procedure with and/or wake up the second serving cell 205-b. That is, in accordance with the two-step SI acquisition approach, the 5G cell may “outsource” sending most of the 6G-related SI to 6G cell itself. As such, in accordance with the two-step SI acquisition approach, the SI required to access the second serving cell 205-b may be divided across signaling received from both serving cells 205-a, 205-b.

For example, in the context of the two-step SI acquisition approach, the 5G SIBs (e.g., broadcast SI messages 230-a) may include bit fields that indicate an initial downlink BWP, an initial CORESET (CORESET0), and/or search space (e.g., search space 0) for the second serving cell 205-b. In this example, in order to retrieve the remaining SI that will be used to access the second serving cell 205-b, the UE 115-a (and/or first serving cell 205-a) may have to wake up the second serving cell 205-b so that the second serving cell 205-b can transmit/broadcast SIBs (e.g., broadcast SI messages 230-b) that include the remaining SI that will be used to access the second serving cell 205-b. In this regard, the UE 115-a may use the SI received in the broadcast SI messages 230-a from the first serving cell 205-a to transmit RACH messages 235-a directly to the second serving cell 205-b, and/or to transmit RACH messages 235-c that will be relayed by the first serving cell 205-a to the second serving cell 205-b (as RACH messages 235-d).

For instance, in some cases, if the incoming 6G UE 115-a requires full information (SI) of the 6G cell, it may use the SI received via the broadcast SI messages 230-b to transmit a RACH message 235-a (e.g., PRACH) directly to 6G cell in order to wake up 6G cell. In such cases, the 6G cell (e.g., second serving cell 205-b) may be expected to periodically “wake up” (e.g., transition from a sleep or inactive state to an active state) in order to monitor the 6G RACH occasions used to receive the RACH messages 235-a. The RACH messages 235-a may include a WUS or otherwise may request for the second serving cell 205-b to wake up. Subsequently, after receiving the RACH messages 235-a/WUS (and transitioning to an active state), the 6G cell may start broadcasting its own SIBs (e.g., broadcast SI messages 230-b), where the SIBs may include the rest of the SI that will be used for accessing the second serving cell 205-b and that was not included in the 5G SIBs (e.g., broadcast SI messages 230-a) from the 5G cell. In this example, the UE 115-a may use the additional SI within the broadcast SI messages 230-b received from the second serving cell 205-b to perform a RACH procedure and establish a connection with the second serving cell 205-b.

In additional or alternative cases, instead of transmitting RACH messages 235-a and/or WUSs directly to the second serving cell 205-b, the UE 115-a may transmit the RACH messages 235-c and/or WUSs to the first serving cell 205-a, where the first serving cell 205-a is configured to forward or relay the information/messages to the second serving cell 205-b. For example, as described previously herein, the UE 115-a may receive broadcast SI messages 230-a from the first serving cell 205-a (without establishing a connection with the first serving cell 205-a), where the broadcast SI messages 230-a include some SI for accessing the second serving cell 205-b. The UE 115-a may use the SI included within the broadcast SI messages 230-a to transmit a RACH message 235-c (and/or WUS) to the first serving cell 205-a to notify/inform the first serving cell 205-a that the UE 115-a wants to access the second serving cell 205-b. In this example, the first serving cell 205-a may forward or relay the RACH message 235-d and/or WUS to the second serving cell 205-b to “wake up” the second serving cell 205-b. Subsequently, after receiving the RACH messages 235-b/WUS (and transitioning to an active state) from the first serving cell 205-a, the 6G cell may start broadcasting its own SIBs (e.g., broadcast SI messages 230-b), where the SIBs may include the rest of the SI that will be used for accessing the second serving cell 205-b and that was not included in the 5G SIBs (e.g., broadcast SI messages 230-a) from the 5G cell. In this example, the UE 115-a may use the additional SI within the broadcast SI messages 230-b received from the second serving cell 205-b to perform a RACH procedure and establish a connection with the second serving cell 205-b.

In both alternatives (e.g., UE 115-a transmitting RACH messages 235-a directly to the second serving cell 205-b, or to the first serving cell 205-a for relay to the second serving cell 205-b), the first serving cell 205-a may consume less energy as compared to the one-step SI acquisition approach. In particular, the broadcast SI messages 230-a transmitted by the first serving cell 205-a in accordance with the two-step SI acquisition approach may include less SI (and therefore less data/bit fields) as compared to the broadcast SI messages 230-a transmitted by the first serving cell 205-a in accordance with the one-step SI acquisition approach, thereby reducing the power consumption associated with the first serving cell 205-a. Further, the two-step SI acquisition approach may still reduce power consumption at the second serving cell 205-b as the second serving cell 205-b may still remain in a sleep state (e.g., idle, inactive, or other low-power state) until it receives a WUS from the UE 115-a and/or first serving cell 205-a.

In some aspects, information within the broadcast SI messages 230-a transmitted by the first serving cell 205-a may be interpreted differently depending on whether the information is to be applied to communications with the first serving cell 205-a (e.g., 5G communications) or the second serving cell 205-b (e.g., 6G communications). In other words, 5G-capable UEs 115 that will use the SI for 5G communications with the first serving cell 205-a will interpret the bit fields differently as compared to 6G-capable UEs 115 that will use the SI for 6G communications with the second serving cell 205-b. The use of separate interpretations for the same bit fields within the broadcast SI messages 230 may be useful when 6G-capable UEs 115 know that the 5G cell (e.g., first serving cell 205-a) is associated with the 6G cell (e.g., second serving cell 205-b), whether the 5G cell is MRSSed with the 6G cell or associated with a reframed 6G cell.

For example, the broadcast SI messages 230-a may include one or more bit fields associated with a PDCCH or SIB configuration (e.g., pdcch-ConfigSIB1). In this example, 5G UEs 115 may interpret the bit fields for the pdcch-ConfigSIB1 in accordance with a first interpretation for 5G communications with the first serving cell 205-a. Comparatively, 6G UEs 115 may interpret the bit fields for the pdcch-ConfigSIB1 in accordance with a second interpretation for 6G communications with the second serving cell 205-b. With the new interpretation for the bit fields of the pdcch-ConfigSIB1 for the 6G cell, 6G-capable UEs 115 may not be expected to detect and decode 5G SIB1 messages to get the required information to acquire 6G SIB. Instead, the 6G-capable UEs 115 may directly detect and decode the 6G SIBs. In this regard, allowing for different interpretations of the same bit fields within the broadcast SI messages 230-a may result in lower latency and lower power consumption for 6G-capable UEs 115 compared to some previous approaches, and may result in lower 5G network overhead and power consumption.

Both the one-step SI acquisition approach and the two-step SI acquisition approach may be well suited for migration scenarios with following conditions: (1) the 5G and 6G cells are collocated, (2) the frequency gap between the 5G and 6G cells is relatively small, and (3) the RF and antenna components are shared between the 5G and the 6G cells. When the 5G and 6G cells are collocated, the serving cells 205 may be coordinated with each other, and may therefore cooperate (e.g., communicate) with each other with negligible timing misalignment. Moreover, when the serving cells 205 are collocated, the UE 115-a may be able to rely on the timing information obtained/determined based on communications with the 5G cell when initiating access with the 6G cell. Additionally, when the frequency gap between the cells is relatively small (e.g., less than a threshold), the UE 115-a may be able to rely on measurements performed on signals received from the first serving cell 205-a when initiating access with the second serving cell 205-b. This frequency gap condition may be satisfied in cases where the first serving cell 205-a (e.g., 5G cell) and the second serving cell 205-b (e.g., 6G cell) are MRSSed with each other. Lastly, if the RF and antenna components are shared between the serving cells 205, the UE 115-a may be able to rely on the spatial information it acquires/determines from the first serving cell 205-a when initiating access to the second serving cell 205-b.

When the serving cells 205 are collocated, the serving cells 205 may be said to be “coordinated” in that schedulers at the serving cells 205 communicate with one another, and differences in TA values and pathlosses realized by the UE 115-a from both serving cells 205 are negligible. However, in cases where the first serving cell 205-a and the second serving cell 205-b are not collocated (e.g., not supported by the same network entity 105), the assumptions/conditions described above may not hold. In such cases, the second serving cell 205-b (e.g., 6G cell) may be configured to transmit/broadcast SSBs 240-b when it wakes up.

For example, in some cases, the first serving cell 205-a and the second serving cell 205-b may not be collocated. In cases where the serving cells 205 are not collocated, the UE 115-a may not be able to transmit RACH messages 235-a (e.g., PRACHs) directly to the second serving cell 205-b. As such, in the context of both the one-step SI acquisition approach and/or the two-step SI acquisition approach, the second serving cell 205-b may receive a RACH message 235-d and/or WUS that is relayed/forwarded by the first serving cell 205-a, and may “wake up” by transitioning to an active state. In this example, and in cases in which serving cells 205-a, 205-b are not collocated, the second serving cell 205-b may transmit/broadcast its own SSBs 240-b after waking up. In this regard, because the UE 115-a cannot rely on spatial information, TA values, and pathlosses associated with the first serving cell 205-a (because the cells are not collocated), the UE 115-a may utilize the SSBs 240-b received from the second serving cell 205-b to determine separate spatial information, TA values, pathloss, and other information associated with the second serving cell 205-b. Subsequently, the UE 115-a may perform the RACH procedure with the second serving cell 205-b (as described previously herein) based on the information determined/acquired from the SSBs 240-b.

In this regard, in some cases, such as in cases where the cells are collocated, the UE 115-a may rely on measurements of the first serving cell 205-a (e.g., 5G cell) to access the second serving cell 205-b (e.g., 6G cell). In other cases, such as in cases where the cells are not collocated (e.g., collocation condition not satisfied), measurements performed on signals (e.g., SSBs 240-a) from the first serving cell 205-a may not be useful for accessing the second serving cell 205-b. As such, in some cases, the 5G cell (e.g., first serving cell 205-a) may be associated with a set of 6G cells (e.g., set of serving cells 205 including the second serving cell 205-b) instead of only one 6G cell.

In some cases, the 5G cell (e.g., first serving cell 205-a) may be configured to “wake up” more than one 6G cell so that the notified 6G cells may begin transmitting SSBs 240-b to enable the UE 115-a to access the respective 6G cells. In this example, the woken up 6G cells may include all the 6G cells associated with the 5G cell, or only a subset of the 6G cells associated with the 5G cell. The 5G cell may also indicate to the UE 115-a information associated with the SSBs 240-b of the 6G cells (e.g., time/frequency resources for the SSBs 240-b) to enable the UE 115-a to perform measurements on the SSBs 240-b received from the 6G cells. In such cases, the UE 115-a may have variety of options (among 6G cells) to access the 6G network, and may perform cell selection across the indicated 6G cells. Once a 6G cell is selected, the other awakened 6G cells may fall back or otherwise return to a sleep state (e.g., idle state, inactive state, other low-power state).

In cases where the UE 115-a utilizes SSBs 240-a from the first serving cell 205-a (e.g., 5G cell) to access the second serving cell 205-b (in both the one-step SI acquisition approach, the two-step SI acquisition approach), the UE 115-a may determine the cell ID of the second serving cell 205-b (e.g., 6G cell) according to various implementations. In accordance with a first implementation, the cell ID for the second serving cell 205-b (e.g., 6G cell) may be the same as (equal to) the cell ID for the first serving cell 205-a (e.g., 5G cell). However, such an implementation may limit network operations to always choose identical IDs for both 5G and 6G cells. In accordance with a second implementation, the second serving cell 205-b (e.g., 6G cell) may send its own SSBs 240-b to the UE 115-b after waking up, where the SSBs 240-b indicate the cell ID of the second serving cell 205-b. However, as discussed previously herein, requiring the second serving cell 205-b to transmit SSBs 240-b after waking up may increase network power consumption at the second serving cell 205-b. In accordance with a third implementation, the first serving cell 205-a (e.g., 5G cell) may be configured to indicate the cell ID associated with the second serving cell 205-b (e.g., 6G cell) to the UE 115-a via the broadcast SI messages 230-a (e.g., via the extended 5G SIBs). In such cases, the second serving cell 205-b (e.g., 6G cell) may not be required or expected to broadcast its own SSBs 240-b to the UE 115-a thereby resulting in decreased power consumption and more flexible network operation.

FIG. 3 shows an example of a process flow 300 that supports system information for assisted access in wireless communications in accordance with one or more aspects of the present disclosure. Aspects of the process flow 300 may implement, or be implemented by, aspects of the wireless communications system 100, the wireless communications system 200, or both. For example, the process flow 300 illustrates signaling and configurations that enable a UE 115-b to utilize signaling from a first serving cell to access another serving cell, and without ever fully connecting with the first serving cell, as described previously herein. In particular, the signaling shown in FIG. 3 illustrates an example of the one-step SI acquisition approach described herein.

The process flow 300 includes a UE 115-b, a first serving cell 305-a, and a second serving cell 305-b, which may be examples of UEs 115, network entities 105, serving cells 205, and other wireless devices as described herein. For example, the UE 115-b, the first serving cell 305-a, and the second serving cell 305-b illustrated in FIG. 3 may include examples of the UE 115-a, the first serving cell 205-a, and the second serving cell 205-b, respectively, as illustrated in FIG. 2. In this regard, the first serving cell 305-a and the second serving cell 305-b may be associated with (e.g., supported by) the same or different network entities 105, and may be configured to communicate using the same or different frequency bands/RATs. For instance, in some cases, the first serving cell 305-a may include a 5G cell, and the second serving cell 305-b may include a 6G cell.

In some examples, the operations illustrated in process flow 300 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 310, the UE 115-b may receive one or more broadcast SI messages from the first serving cell 305-a. The broadcast SI messages may include MIBs, SIBs (e.g., SIB1s), SSBs, or any combination thereof. For example, in some cases, the UE 115-b may perform measurements on SSBs received from the first serving cell 305-a. As described previously herein, in cases where the serving cells 305-a, 305-b are collocated, the UE 115-b may be able to use measurements and assumptions (e.g., pathloss, spatial information, TA values) that are based on the SSBs received from the first serving cell 305-a to access the second serving cell 305-b. The first serving cell 205-a may transmit the broadcast SI messages 230-a using 5G signaling (e.g., within 5G resources, using 5G communication protocols).

In some aspects, the broadcast SI messages at 310 (e.g., 5G SIBs) may be extended or modified (e.g., new SIB formats) to carry additional 6G-related information. In other words, the 5G broadcast SI messages may include one or more bit fields used to communicate 6G-related SI that is usable by the UE 115-a for accessing the second serving cell 305-b. In some aspects, UEs 115 that are only capable of 5G communications may be configured to ignore the bit fields associated with the 6G-related SI. Moreover, in cases where new SIB formats are used for the broadcast SI messages that communicate 6G-related SI, 5G-capable UEs 115 (e.g., UEs 115 that are not capable of performing 6G communications) may ignore or otherwise refrain from reading the new SIB formats (e.g., refrain from decoding or processing the SIB formats with 6G-related SI).

In some cases, the first serving cell 305-a may be configured to transmit/broadcast the SI messages at 310 that include the SI for accessing the second serving cell 305-b on pre-defined or pre-configured resources. In other words, the resources used by the first serving cell 305-a may be pre-configured and/or hardcoded into the UE 115-b so that the UE 115-b is be able to monitor for and receive the broadcast SI messages from the first serving cell 305-a without ever establishing a connection with the first serving cell 305-a. That is, the UE 115-b may be able to receive the broadcast SI messages via 5G signaling without ever actually performing a RACH procedure with (or establishing an RRC connection with) the first serving cell 305-a (e.g., 5G cell).

The broadcast SI messages at 310 may include SI associated with the second serving cell 305-b (e.g., 6G-related SI). The SI included within the broadcast SI messages 230-a may be usable by the UE 115-b to access the second serving cell 305-b. The SI may include RACH configuration information, (e.g., RACH sequences, RACH occasions (ROs), resources of ROs in the time/frequency domains, random access response (RAR) search space configuration, etc.), resources for communicating with the second serving cell 305-b (e.g., uplink bandwidth parts (BWPs) and/or downlink BWPs for communicating with the second serving cell 305-b), a control resource set (CORESET) associated with the second serving cell 305-b, and the like. In this regard, in accordance with the one-step SI acquisition approach, the broadcast SI messages received from the first serving cell 305-a may include all the SI required by the UE 115-b to perform a RACH procedure and access the second serving cell 305-b.

At 315, the UE 115-b and the second serving cell 305-b may perform a RACH procedure (and/or RRC connection procedure) in order to establish a connection between the UE 115-b and the second serving cell 305-b. The UE 115-b may perform a RACH procedure with the second serving cell 305-b (e.g., 6G cell) based on (e.g., in accordance with) the SI received via the first serving cell 305-a at 310. That is, after obtaining the SI from the first serving cell 305-a (e.g., ROs, initial DL/UL BWP, etc.), the UE 115-b may be configured to initiate and continue an initial access procedure with the second serving cell 305-b (e.g., perform a RACH procedure and RRC connection procedure on 6G carriers/frequencies). That is, the UE 115-b may utilize the SI received from the first serving cell 305-a (via the broadcast SI messages at 310) to exchange RACH messages (e.g., PRACH messages) with the second serving cell 305-b as part of a RACH procedure.

In some cases, the UE 115-b may transmit RACH messages 235-a that include a WUS for the second serving cell 305-b to transition from a sleep state to an active state in order to perform the RACH procedure. In this regard, the second serving cell 305-b may be configured to transition from a sleep state (e.g., idle state, inactive state, low-power state) to an active state upon receiving a RACH message and/or WUS from the UE 115-b at 315.

In some cases, such as in cases where the serving cells 305 are collocated, the UE 115-b may utilize spatial information, TA values, pathloss information, and other information determined based on measurements performed on SSBs received from the first serving cell 305-a to communicate with the second serving cell 305-b. That is, when the cells are collocated, the UE 115-b may assume that measurements/determinations performed on the SSBs received from the first serving cell 305-a also apply to the second serving cell 305-b.

In the context of the one-step SI acquisition approach, because the broadcast SI messages from the first serving cell 305-a included all the SI required to access the second serving cell 305-b, the second serving cell 305-b (e.g., 6G cell) may not be required or expected to periodically send SSBs, SIBs, and/or other SI messages. As such, the one-step SI acquisition approach may enable the second serving cell 305-b to reduce (or eliminate) energy consumption used to transmit/broadcast SI messages, thereby reducing energy consumption within the network. Further, enabling the second serving cell 305-b to refrain from broadcasting SI messages may enable the second serving cell 305-b to remain in a sleep state for longer periods of time, thereby further decreasing the energy consumption at the second serving cell 305-b.

At 320, the UE 115-b and the second serving cell 305-b may communicate one or more messages with one another. The UE 115-b and the second serving cell 305-b may communicate the messages with one another at 320 based on receiving the broadcast SI messages at 310, performing the RACH procedure at 315, or both.

FIG. 4 shows an example of a process flow 400 that supports system information for assisted access in wireless communications in accordance with one or more aspects of the present disclosure. Aspects of the process flow 400 may implement, or be implemented by, aspects of the wireless communications system 100, the wireless communications system 200, the process flow 300, or any combination thereof. For example, the process flow 400 illustrates signaling and configurations that enable a UE 115-c to utilize signaling from a first serving cell to access another serving cell, and without ever fully connecting with the first serving cell, as described previously herein. In particular, the signaling shown in FIG. 4 illustrates an example of the two-step SI acquisition approach described herein.

The process flow 400 includes a UE 115-c, a first serving cell 405-a, and a second serving cell 405-b, which may be examples of UEs 115, network entities 105, serving cells 205, 305, and other wireless devices as described herein. For example, the UE 115-c, the first serving cell 405-a, and the second serving cell 405-b illustrated in FIG. 4 may include examples of the UE 115-a, the first serving cell 205-a, and the second serving cell 205-b, respectively, as illustrated in FIG. 2. Similarly, the UE 115-c, the first serving cell 405-a, and the second serving cell 405-b illustrated in FIG. 4 may include examples of the UE 115-b, the first serving cell 305-a, and the second serving cell 305-b, respectively, as illustrated in FIG. 3. In this regard, the first serving cell 405-a and the second serving cell 405-b may be associated with (e.g., supported by) the same or different network entities 105, and may be configured to communicate using the same or different frequency bands/RATs. For instance, in some cases, the first serving cell 405-a may include a 5G cell, and the second serving cell 405-b may include a 6G cell.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 410, the UE 115-c may receive one or more broadcast SI messages from the first serving cell 405-a. The broadcast SI messages may include MIBs, SIBs (e.g., SIB1s), SSBs, or any combination thereof. For example, in some cases, the UE 115-c may perform measurements on SSBs received from the first serving cell 405-a. As described previously herein, in cases where the serving cells 405-a, 405-b are collocated, the UE 115-c may be able to use measurements and assumptions (e.g., pathloss, spatial information, TA values) that are based on the SSBs received from the first serving cell 405-a to access the second serving cell 405-b. The first serving cell 205-a may transmit the broadcast SI messages 230-a using 5G signaling (e.g., within 5G resources, using 5G communication protocols).

As compared to the one-step SI acquisition approach (illustrated in FIG. 3) in which the broadcast SI messages at 310 included all the SI required for the UE 115-b to access the second serving cell 405-b, in accordance with the two-step SI acquisition approach (illustrated in FIG. 4), the broadcast SI messages at 410 may include only a subset of SI that enables the UE 115-c to initiate a RACH procedure with and/or wake up the second serving cell 405-b. That is, in accordance with the two-step SI acquisition approach, the 5G cell may “outsource” sending most of the 6G-related SI to 6G cell itself. As such, in accordance with the two-step SI acquisition approach, the SI required to access the second serving cell 405-b may be divided across signaling received from both serving cells 405-a, 405-b.

For example, in the context of the two-step SI acquisition approach, the 5G SIBs (e.g., broadcast SI messages) may include bit fields that indicate an initial downlink BWP, an initial CORESET (CORESET0), and/or search space (e.g., search space 0) for the second serving cell 405-b. In this example, in order to retrieve the remaining SI that will be used to access the second serving cell 405-b, the UE 115-c (and/or first serving cell 405-a) may have to wake up the second serving cell 405-b so that the second serving cell 205-b can transmit/broadcast SIBs (e.g., broadcast SI messages) that include the remaining SI that will be used to access the second serving cell 205-b. In this regard, the UE 115-c may use the SI received in the broadcast SI messages from the first serving cell 405-a at 410 to transmit RACH messages directly to the second serving cell 405-b, and/or to transmit RACH messages that will be relayed by the first serving cell 405-a to the second serving cell 405-b.

In some aspects, information within the broadcast SI messages at 410 transmitted by the first serving cell 405-a may be interpreted differently depending on whether the information is to be applied to communications with the first serving cell 405-a (e.g., 5G communications) or the second serving cell 405-b (e.g., 6G communications). In other words, 5G-capable UEs 115 that will use the SI for 5G communications with the first serving cell 405-a will interpret the bit fields differently as compared to 6G-capable UEs 115 that will use the SI for 6G communications with the second serving cell 405-b. The use of separate interpretations for the same bit fields within the broadcast SI messages at 410 may be useful when 6G-capable UEs 115 know that the 5G cell (e.g., first serving cell 405-a) is associated with the 6G cell (e.g., second serving cell 405-b), whether the 5G cell is MRSSed with the 6G cell or associated with a reframed 6G cell.

For example, the broadcast SI messages at 410 may include one or more bit fields associated with a PDCCH or SIB configuration (e.g., pdcch-ConfigSIB1). In this example, 5G UEs 115 may interpret the bit fields for the pdcch-ConfigSIB1 in accordance with a first interpretation for 5G communications with the first serving cell 405-a. Comparatively, 6G UEs 115 may interpret the bit fields for the pdcch-ConfigSIB1 in accordance with a second interpretation for 6G communications with the second serving cell 405-b. With the new interpretation for the bit fields of the pdcch-ConfigSIB1 for the 6G cell, 6G-capable UEs 115 may not be expected to detect and decode 5G SIB1 messages to get the required information to acquire 6G SIB. Instead, the 6G-capable UEs 115 may directly detect and decode the 6G SIBs. In this regard, allowing for different interpretations of the same bit fields within the broadcast SI messages 230-a may result in lower latency and lower power consumption for 6G-capable UEs 115 compared to some previous approaches, and may result in lower 5G network overhead and power consumption.

At 415, the UE 115-c may transmit RACH messages and/or WUSs to the first serving cell 405-a. In such cases, at 420, the first serving cell 405-a may be configured to forward or relay the information/messages to the second serving cell 405-b.

For example, as described previously herein, the UE 115-c may the receive broadcast SI messages from the first serving cell 405-a at 410 (without establishing a connection with the first serving cell 405-a), where the broadcast SI messages include some SI for accessing the second serving cell 405-b. The UE 115-c may use the SI included within the broadcast SI messages at 410 to transmit a RACH message (and/or WUS) to the first serving cell 405-a to notify/inform the first serving cell 405-a that the UE 115-c wants to access the second serving cell 405-b. In this example, the first serving cell 405-a may forward or relay the RACH message and/or WUS to the second serving cell 405-b to “wake up” the second serving cell 405-b.

In additional or alternative implementations, the UE 115-c may transmit the RACH messages (and/or WUS) directly to the second serving cell 405-b, as shown and described in step 425.

At 425, the UE 115-c may transmit RACH messages and/or WUSs directly to the second serving cell 405-c. In this regard, step 425 may be considered to be an alternative to the steps shown and described in steps 415 and 420.

At 430, the second serving cell 405-b may transition from a sleep state to an active state. In other words, the second serving cell 405-b may “wake up” based on receiving the RACH messages and/or WUSs from the first serving cell 405-a at 420 and/or from the UE 115-c at 425.

As noted previously herein, in cases where the second serving cell 405-b is collocated with the first serving cell 405-a, the UE 115-c may be able to apply measurements and/or assumptions (e.g., TA values, pathloss information, spatial information) associated with the first serving cell 405-a to the communications with the second serving cell 405-b. As such, in cases where the cells are collocated, the second serving cell 405-b may not need to transmit its own SSBs, and the process flow 400 may proceed directly to step 440.

However, in other cases where the second serving cell 405-b is not collocated with the first serving cell 405-a, the measurements/assumptions performed on SSBs received from the first serving cell 405-a may not be applicable (e.g., useful) for communications with the second serving cell 405-b. As such, in cases where the serving cells are not collocated, the second serving cell 405-b may be expected to transmit its own SSBs so that the UE 115-c can perform measurements and determine TA values, pathloss information, spatial information, and the like. Accordingly, in cases where the cells are not collocated, the process flow 400 may proceed to step 435.

At 435, the second serving cell 405-b may transmit/broadcast one or more SSBs. In particular, in cases where the cells are not collocated, the second serving cell 405-b may transmit SSBs so that the UE 115-c can perform measurements on the SSBs to determine information for communicating with the second serving cell 405-b, such as TA values, pathloss information, spatial information, and the like.

At 440, the second serving cell 405-b may transmit/broadcast one or more additional broadcast SI messages (e.g., SIBs, MIBs), where the additional broadcast SI messages may include the rest of the SI that will be used for accessing the second serving cell 405-b and that was not included in the broadcast SI messages received from the first serving cell 405-a at 410. In this example, the UE 115-c may use the additional SI within the broadcast SI messages received from the second serving cell 405-b at 440 to perform a RACH procedure and establish a connection with the second serving cell 405-b.

At 445, the UE 115-c and the second serving cell 405-b may perform a RACH procedure (and/or RRC connection procedure) in order to establish a connection between the UE 115-c and the second serving cell 405-b. The UE 115-c may perform a RACH procedure with the second serving cell 405-b (e.g., 6G cell) based on (e.g., in accordance with) the SI received via the first serving cell 405-a at 410 and the additional SI received via the second serving cell 405-b at 435. That is, after obtaining the SI from the second serving cell 405-b, the UE 115-c may be configured to initiate and continue an initial access procedure with the second serving cell 405-b (e.g., perform a RACH procedure and RRC connection procedure on 6G carriers/frequencies). That is, the UE 115-c may utilize the SI received from the second serving cell 405-b (via the broadcast SI messages at 440) to exchange RACH messages (e.g., PRACH messages) with the second serving cell 405-b as part of a RACH procedure.

At 450, the UE 115-c and the second serving cell 405-b may communicate one or more messages with one another. The UE 115-c and the second serving cell 405-b may communicate the messages with one another at 420 based on receiving the broadcast SI messages at 410, transmitting/relaying the RACH messages and/or WUSs at 415, 420, and 425, transitioning to an active state at 430, receiving the SSBs at 435, receiving the additional broadcast SI messages at 440, performing the RACH procedure at 445, or any combination thereof.

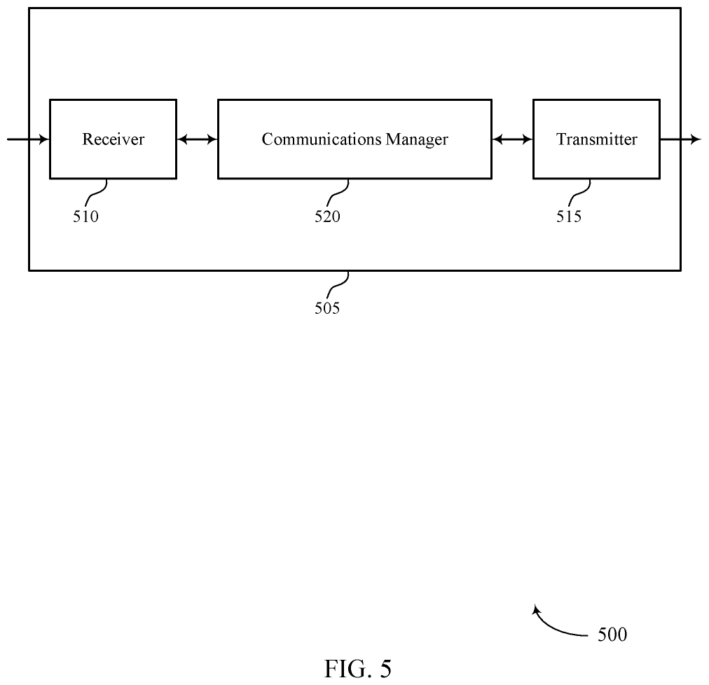

FIG. 5 shows a block diagram 500 of a device 505 that supports system information for assisted access in wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to system information for assisted access in wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to system information for assisted access in wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of system information for assisted access in wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

For example, the communications manager 520 is capable of, configured to, or operable to support a means for receiving a broadcast SI message from a first serving cell, where the broadcast SI message includes SI for connecting to a second serving cell, and where the broadcast SI message includes an SSB message, a SIB message, a MIB message, or any combination thereof. The communications manager 520 is capable of, configured to, or operable to support a means for transmitting a RACH message to the first serving cell or the second serving cell based on receiving the SI included within the broadcast SI message. The communications manager 520 is capable of, configured to, or operable to support a means for performing a random access procedure with the second serving cell to establish a wireless connection with the second serving cell based on transmitting the RACH message. The communications manager 520 is capable of, configured to, or operable to support a means for communicating one or more messages with the second serving cell based on the random access procedure.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques that enable UEs 115 to utilize broadcast SI messages received from a first serving cell (and/or first RAT) to access a second serving cell (and/or a second RAT), and without fully connecting with the first serving cell. As such, techniques described herein may reduce control signaling overhead (by reducing or eliminating signaling to establish a connection between the UE 115 and the first cell). Moreover, techniques described herein may reduce latency of communications at the UE 115 by reducing the amount of time it takes for the UE 115 to connect with the second serving cell.

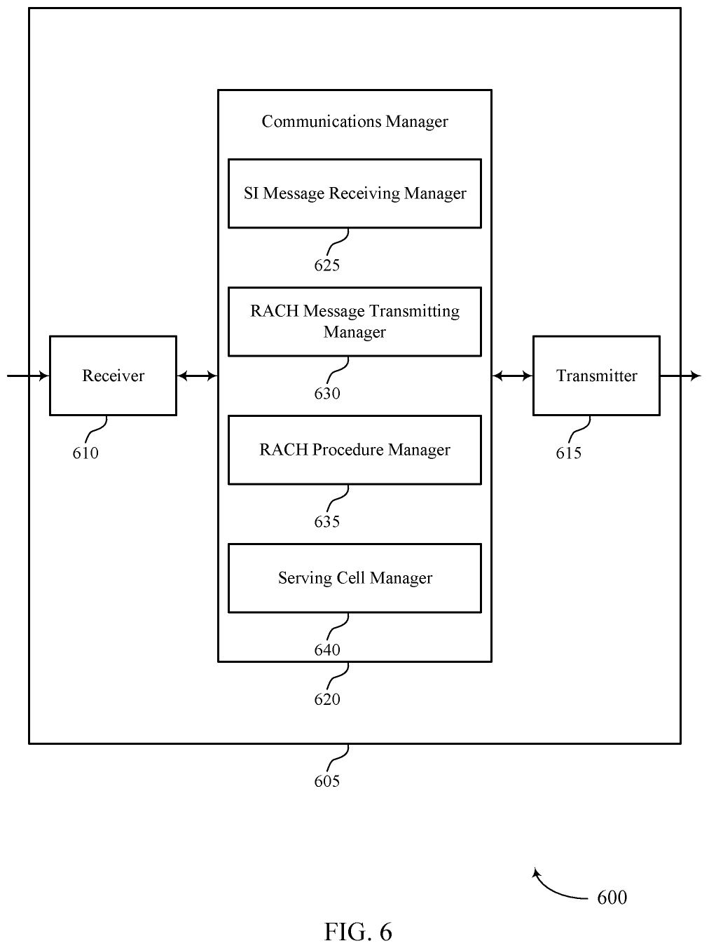

FIG. 6 shows a block diagram 600 of a device 605 that supports system information for assisted access in wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to system information for assisted access in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to system information for assisted access in wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of system information for assisted access in wireless communications as described herein. For example, the communications manager 620 may include an SI message receiving manager 625, a RACH message transmitting manager 630, a RACH procedure manager 635, a serving cell manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The SI message receiving manager 625 is capable of, configured to, or operable to support a means for receiving a broadcast SI message from a first serving cell, where the broadcast SI message includes SI for connecting to a second serving cell, and where the broadcast SI message includes an SSB message, a SIB message, a MIB message, or any combination thereof. The RACH message transmitting manager 630 is capable of, configured to, or operable to support a means for transmitting a RACH message to the first serving cell or the second serving cell based on receiving the SI included within the broadcast SI message. The RACH procedure manager 635 is capable of, configured to, or operable to support a means for performing a random access procedure with the second serving cell to establish a wireless connection with the second serving cell based on transmitting the RACH message. The serving cell manager 640 is capable of, configured to, or operable to support a means for communicating one or more messages with the second serving cell based on the random access procedure.

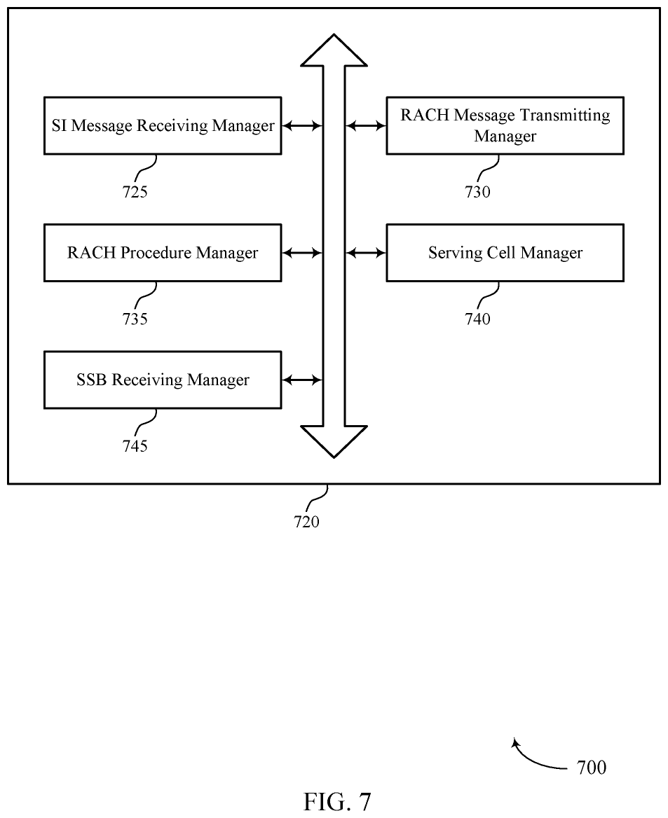

FIG. 7 shows a block diagram 700 of a communications manager 720 that supports system information for assisted access in wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of system information for assisted access in wireless communications as described herein. For example, the communications manager 720 may include an SI message receiving manager 725, a RACH message transmitting manager 730, a RACH procedure manager 735, a serving cell manager 740, an SSB receiving manager 745, or any combination thereof. Each of these components, or components or subcomponents thereof (e.g., one or more processors, one or more memories), may communicate, directly or indirectly, with one another (e.g., via one or more buses).

The SI message receiving manager 725 is capable of, configured to, or operable to support a means for receiving a broadcast SI message from a first serving cell, where the broadcast SI message includes SI for connecting to a second serving cell, and where the broadcast SI message includes an SSB message, a SIB message, a MIB message, or any combination thereof. The RACH message transmitting manager 730 is capable of, configured to, or operable to support a means for transmitting a RACH message to the first serving cell or the second serving cell based on receiving the SI included within the broadcast SI message. The RACH procedure manager 735 is capable of, configured to, or operable to support a means for performing a random access procedure with the second serving cell to establish a wireless connection with the second serving cell based on transmitting the RACH message. The serving cell manager 740 is capable of, configured to, or operable to support a means for communicating one or more messages with the second serving cell based on the random access procedure.

In some examples, the broadcast SI message includes one or more bit fields that indicate whether the broadcast SI message includes the SI for connecting to the second serving cell.

In some examples, the SI for connecting to the second serving cell includes one or more RACH sequences for transmitting the RACH message, resources associated with RACH occasions, one or more RAR search space configurations, one or more BWPs for communicating with the second serving cell, a CORESET associated with the second serving cell, or any combination thereof.

In some examples, the SI included within the broadcast SI message indicates whether a first set of resources for communicating with the first serving cell are located on a separate component carrier relative to a second set of resources for communicating with the second serving cell, or whether the first set of resources for communicating with the first serving cell are within a same component carrier as the second set of resources for communicating with the second serving cell.

In some examples, to support transmitting the RACH message, the RACH message transmitting manager 730 is capable of, configured to, or operable to support a means for transmitting the RACH message to the second serving cell in accordance with the SI included within the broadcast SI message.

In some examples, the SI message receiving manager 725 is capable of, configured to, or operable to support a means for receiving a second broadcast SI message from the second serving cell based on transmitting the RACH message, where the second broadcast SI message includes additional SI for connecting to the second serving cell, where the random access procedure is performed with the second serving cell in accordance with the SI and the additional SI.

In some examples, to support transmitting the RACH message, the RACH message transmitting manager 730 is capable of, configured to, or operable to support a means for transmitting the RACH message to the second serving cell, where the RACH message includes a wake-up indication for the second serving cell, and where the second broadcast SI message is received based on the wake-up indication.

In some examples, to support transmitting the RACH message, the RACH message transmitting manager 730 is capable of, configured to, or operable to support a means for transmitting the RACH message to the first serving cell, where the RACH message includes a wake-up indication for the second serving cell and a request for the first serving cell to relay the RACH message and the wake-up indication to the second serving cell, and where the second broadcast SI message received based on the wake-up indication.

In some examples, the second broadcast SI message includes a SIB message.

In some examples, the SI included within the broadcast SI message includes one or more bit fields associated with a SIB configuration. In some examples, the one or more bit fields are associated with a first interpretation if the SIB configuration is applied to the first serving cell. In some examples, the one or more bit fields are associated with a second interpretation if the SIB configuration is applied to the second serving cell.

In some examples, the SSB receiving manager 745 is capable of, configured to, or operable to support a means for receiving one or more SSB messages from the second serving cell based on transmitting the RACH message, where performing the random access procedure is based on receiving the one or more SSB messages.

In some examples, the first serving cell and the second serving cell are supported by a same network entity.

In some examples, the first serving cell is associated with a first RAT. In some examples, the second serving cell is associated with a second RAT.

In some examples, the first RAT includes a 5G RAT, an NR access technology, or both. In some examples, the second RAT includes a 6G RAT.

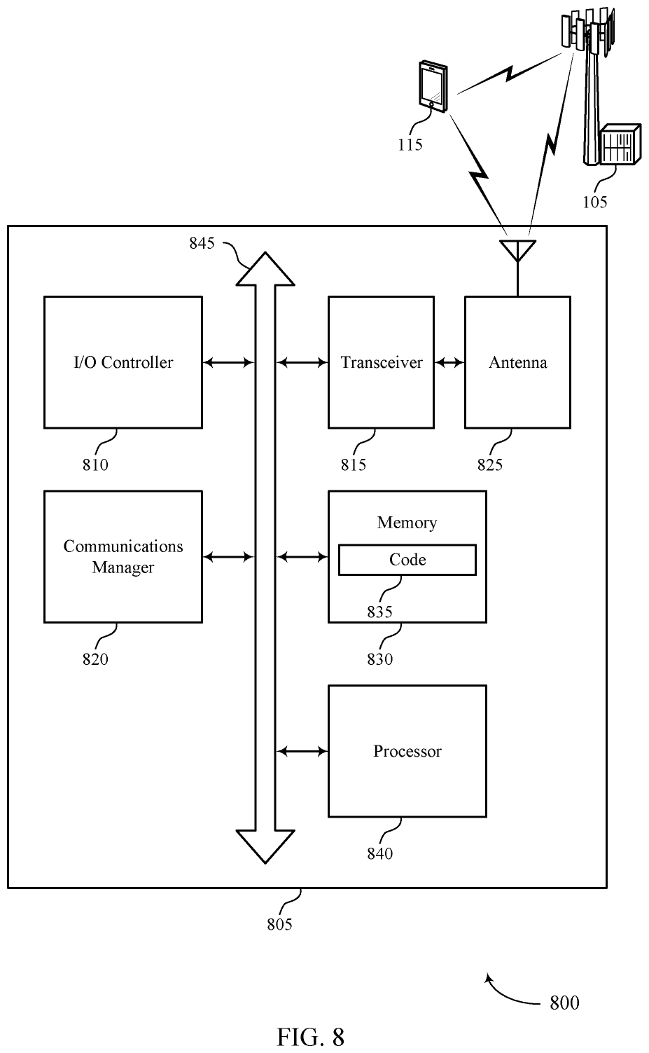

FIG. 8 shows a diagram of a system 800 including a device 805 that supports system information for assisted access in wireless communications in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting system information for assisted access in wireless communications). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

For example, the communications manager 820 is capable of, configured to, or operable to support a means for receiving a broadcast SI message from a first serving cell, where the broadcast SI message includes SI for connecting to a second serving cell, and where the broadcast SI message includes an SSB message, a SIB message, a MIB message, or any combination thereof. The communications manager 820 is capable of, configured to, or operable to support a means for transmitting a RACH message to the first serving cell or the second serving cell based on receiving the SI included within the broadcast SI message. The communications manager 820 is capable of, configured to, or operable to support a means for performing a random access procedure with the second serving cell to establish a wireless connection with the second serving cell based on transmitting the RACH message. The communications manager 820 is capable of, configured to, or operable to support a means for communicating one or more messages with the second serving cell based on the random access procedure.

By including or configuring the communications manager 820 in accordance with examples as described herein, the device 805 may support techniques that enable UEs 115 to utilize broadcast SI messages received from a first serving cell (and/or first RAT) to access a second serving cell (and/or a second RAT), and without fully connecting with the first serving cell. As such, techniques described herein may reduce control signaling overhead (by reducing or eliminating signaling to establish a connection between the UE 115 and the first cell). Moreover, techniques described herein may reduce latency of communications at the UE 115 by reducing the amount of time it takes for the UE 115 to connect with the second serving cell.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of system information for assisted access in wireless communications as described herein, or the at least one processor 840 and the at least one memory 830 may be otherwise configured to, individually or collectively, perform or support such operations.

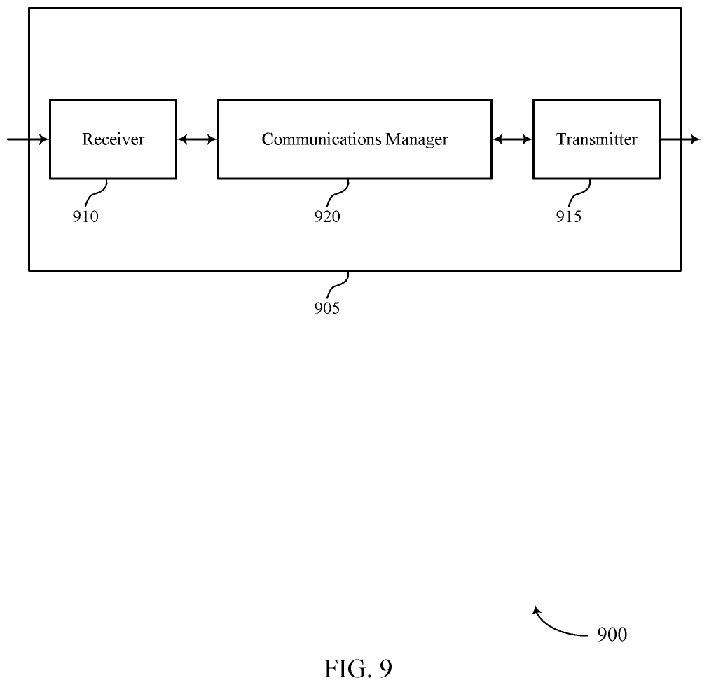

FIG. 9 shows a block diagram 900 of a device 905 that supports system information for assisted access in wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of system information for assisted access in wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for transmitting a broadcast SI message to a UE, where the broadcast SI message includes SI usable by the UE for connecting to a second serving cell, and where the broadcast SI message includes an SSB message, a SIB message, a MIB message, or any combination thereof. The communications manager 920 is capable of, configured to, or operable to support a means for receiving a RACH message from the UE based on transmitting the SI included within the broadcast SI message. The communications manager 920 is capable of, configured to, or operable to support a means for relaying the RACH message to the second serving cell to facilitate a random access procedure between the UE and the second serving cell.

For example, the communications manager 920 is capable of, configured to, or operable to support a means for receiving, from a first serving cell or a UE, a wake-up signal that indicates the second serving cell to wake-up from a sleep state to an active state. The communications manager 920 is capable of, configured to, or operable to support a means for performing a random access procedure with the UE based on receiving the wake-up signal. The communications manager 920 is capable of, configured to, or operable to support a means for communicating one or more messages with the UE based on the random access procedure.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques that enable UEs 115 to utilize broadcast SI messages received from a first serving cell (and/or first RAT) to access a second serving cell (and/or a second RAT), and without fully connecting with the first serving cell. As such, techniques described herein may reduce control signaling overhead (by reducing or eliminating signaling to establish a connection between the UE 115 and the first cell). Moreover, techniques described herein may reduce latency of communications at the UE 115 by reducing the amount of time it takes for the UE 115 to connect with the second serving cell.

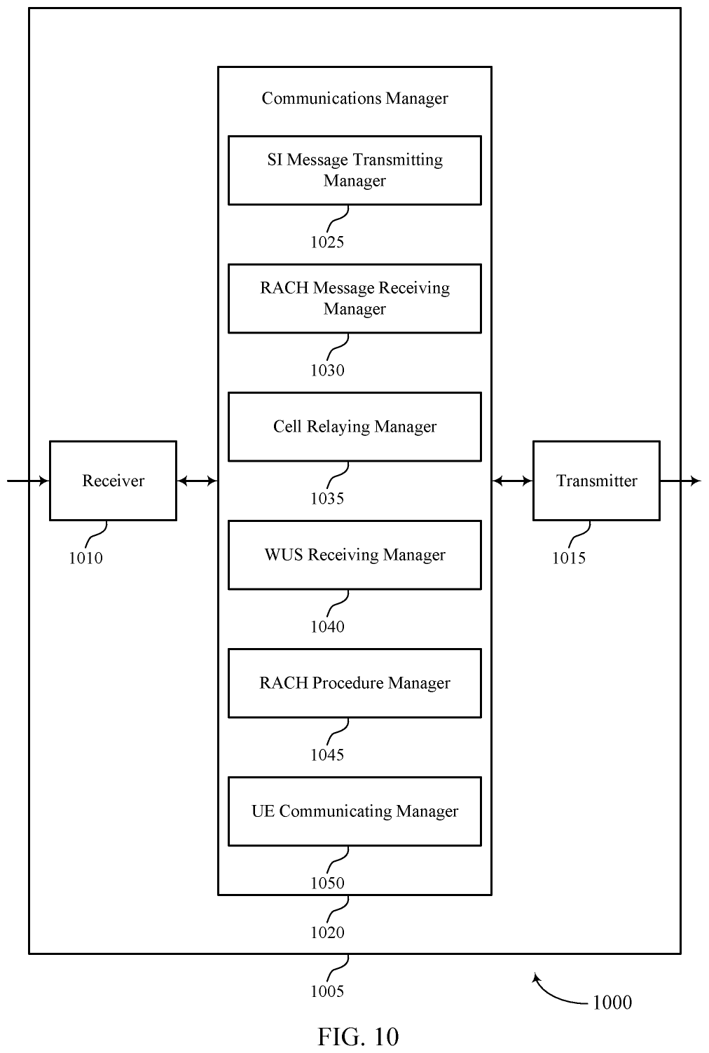

FIG. 10 shows a block diagram 1000 of a device 1005 that supports system information for assisted access in wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of system information for assisted access in wireless communications as described herein. For example, the communications manager 1020 may include an SI message transmitting manager 1025, a RACH message receiving manager 1030, a cell relaying manager 1035, a WUS receiving manager 1040, a RACH procedure manager 1045, a UE communicating manager 1050, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The SI message transmitting manager 1025 is capable of, configured to, or operable to support a means for transmitting a broadcast SI message to a UE, where the broadcast SI message includes SI usable by the UE for connecting to a second serving cell, and where the broadcast SI message includes an SSB message, a SIB message, a MIB message, or any combination thereof. The RACH message receiving manager 1030 is capable of, configured to, or operable to support a means for receiving a RACH message from the UE based on transmitting the SI included within the broadcast SI message. The cell relaying manager 1035 is capable of, configured to, or operable to support a means for relaying the RACH message to the second serving cell to facilitate a random access procedure between the UE and the second serving cell.

The WUS receiving manager 1040 is capable of, configured to, or operable to support a means for receiving, from a first serving cell or a UE, a wake-up signal that indicates the second serving cell to wake-up from a sleep state to an active state. The RACH procedure manager 1045 is capable of, configured to, or operable to support a means for performing a random access procedure with the UE based on receiving the wake-up signal. The UE communicating manager 1050 is capable of, configured to, or operable to support a means for communicating one or more messages with the UE based on the random access procedure.

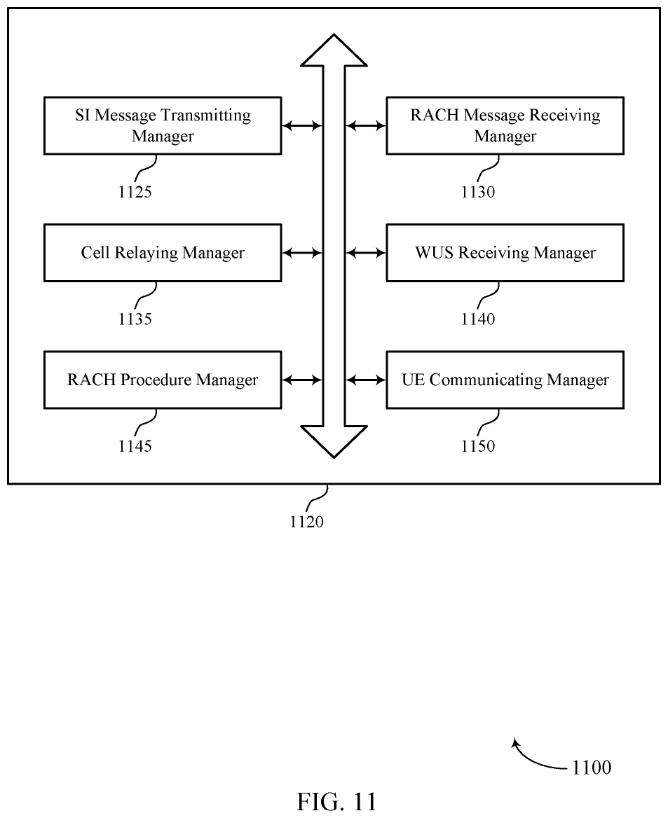

FIG. 11 shows a block diagram 1100 of a communications manager 1120 that supports system information for assisted access in wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of system information for assisted access in wireless communications as described herein. For example, the communications manager 1120 may include an SI message transmitting manager 1125, a RACH message receiving manager 1130, a cell relaying manager 1135, a WUS receiving manager 1140, a RACH procedure manager 1145, a UE communicating manager 1150, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The SI message transmitting manager 1125 is capable of, configured to, or operable to support a means for transmitting a broadcast SI message to a UE, where the broadcast SI message includes SI usable by the UE for connecting to a second serving cell, and where the broadcast SI message includes an SSB message, a SIB message, a MIB message, or any combination thereof. The RACH message receiving manager 1130 is capable of, configured to, or operable to support a means for receiving a RACH message from the UE based on transmitting the SI included within the broadcast SI message. The cell relaying manager 1135 is capable of, configured to, or operable to support a means for relaying the RACH message to the second serving cell to facilitate a random access procedure between the UE and the second serving cell.

In some examples, the broadcast SI message includes one or more bit fields that indicate whether the broadcast SI message includes the SI for connecting to the second serving cell.

In some examples, the SI for connecting to the second serving cell includes one or more RACH sequences for transmitting the RACH message, resources associated with RACH occasions, one or more RAR search space configurations, one or more BWPs for communicating with the second serving cell, a CORESET associated with the second serving cell, or any combination thereof.

In some examples, the SI included within the broadcast SI message indicates whether a first set of resources for communicating with the first serving cell are located on a separate component carrier relative to a second set of resources for communicating with the second serving cell, or whether the first set of resources for communicating with the first serving cell are within a same component carrier as the second set of resources for communicating with the second serving cell.

In some examples, the RACH message includes a wake-up indication for the second serving cell and a request for the first serving cell to relay the RACH message and the wake-up indication to the second serving cell. In some examples, relaying the RACH message is based on receiving the wake-up indication and the request.

In some examples, the SI included within the broadcast SI message includes one or more bit fields associated with a SIB configuration. In some examples, the one or more bit fields are associated with a first interpretation if the SIB configuration is applied to the first serving cell. In some examples, the one or more bit fields are associated with a second interpretation if the SIB configuration is applied to the second serving cell.

In some examples, to support relaying the RACH message, the cell relaying manager 1135 is capable of, configured to, or operable to support a means for relaying the RACH message to a set of multiple additional serving cells including the second serving cell.

In some examples, the first serving cell and the second serving cell are supported by a same network entity.

In some examples, the first serving cell is associated with a first RAT. In some examples, the second serving cell is associated with a second RAT.

In some examples, the first RAT includes a 5G RAT, an NR access technology, or both. In some examples, the second RAT includes a 6G RAT.

The WUS receiving manager 1140 is capable of, configured to, or operable to support a means for receiving, from a first serving cell or a UE, a wake-up signal that indicates the second serving cell to wake-up from a sleep state to an active state. The RACH procedure manager 1145 is capable of, configured to, or operable to support a means for performing a random access procedure with the UE based on receiving the wake-up signal. The UE communicating manager 1150 is capable of, configured to, or operable to support a means for communicating one or more messages with the UE based on the random access procedure.

In some examples, the SI message transmitting manager 1125 is capable of, configured to, or operable to support a means for transmitting a SI message to the UE based on receiving the wake-up signal, where the SI message includes SI usable by the UE for connecting with the second serving cell.

In some examples, the RACH message receiving manager 1130 is capable of, configured to, or operable to support a means for receiving a RACH message from the UE, where the wake-up signal is received via the RACH message, and where performing the random access procedure is based on receiving the RACH message.

In some examples, the RACH message receiving manager 1130 is capable of, configured to, or operable to support a means for receiving, from the first serving cell, a RACH message relayed associated with the UE, where the wake-up signal is received via the RACH message, and where performing the random access procedure is based on receiving the RACH message.

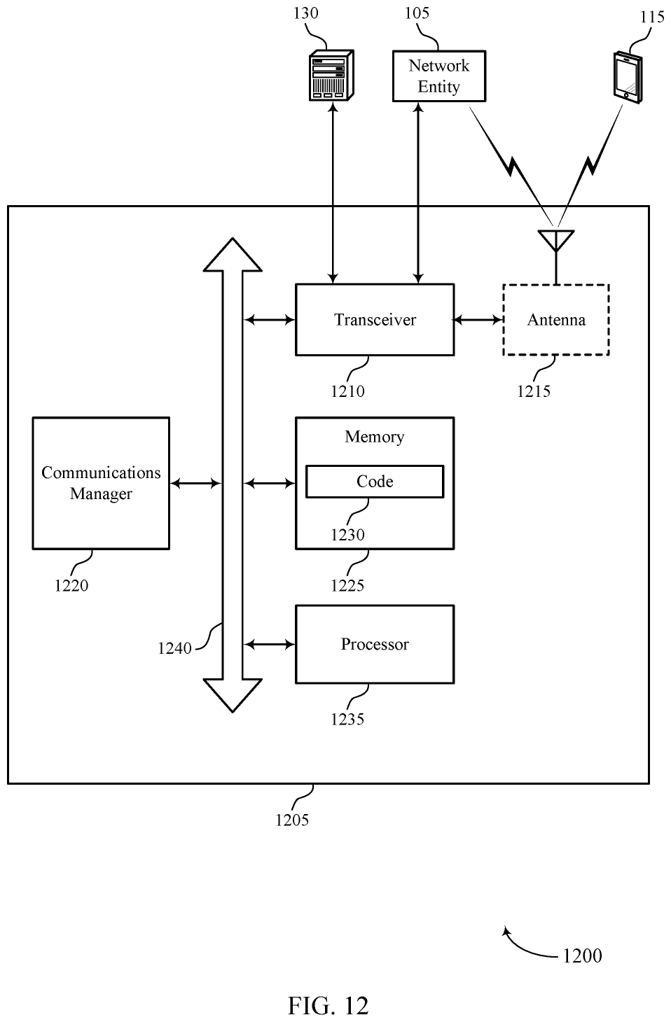

FIG. 12 shows a diagram of a system 1200 including a device 1205 that supports system information for assisted access in wireless communications in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting system information for assisted access in wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

For example, the communications manager 1220 is capable of, configured to, or operable to support a means for transmitting a broadcast SI message to a UE, where the broadcast SI message includes SI usable by the UE for connecting to a second serving cell, and where the broadcast SI message includes an SSB message, a SIB message, a MIB message, or any combination thereof. The communications manager 1220 is capable of, configured to, or operable to support a means for receiving a RACH message from the UE based on transmitting the SI included within the broadcast SI message. The communications manager 1220 is capable of, configured to, or operable to support a means for relaying the RACH message to the second serving cell to facilitate a random access procedure between the UE and the second serving cell.

For example, the communications manager 1220 is capable of, configured to, or operable to support a means for receiving, from a first serving cell or a UE, a wake-up signal that indicates the second serving cell to wake-up from a sleep state to an active state. The communications manager 1220 is capable of, configured to, or operable to support a means for performing a random access procedure with the UE based on receiving the wake-up signal. The communications manager 1220 is capable of, configured to, or operable to support a means for communicating one or more messages with the UE based on the random access procedure.

By including or configuring the communications manager 1220 in accordance with examples as described herein, the device 1205 may support techniques that enable UEs 115 to utilize broadcast SI messages received from a first serving cell (and/or first RAT) to access a second serving cell (and/or a second RAT), and without fully connecting with the first serving cell. As such, techniques described herein may reduce control signaling overhead (by reducing or eliminating signaling to establish a connection between the UE 115 and the first cell). Moreover, techniques described herein may reduce latency of communications at the UE 115 by reducing the amount of time it takes for the UE 115 to connect with the second serving cell.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of system information for assisted access in wireless communications as described herein, or the at least one processor 1235 and the at least one memory 1225 may be otherwise configured to, individually or collectively, perform or support such operations.

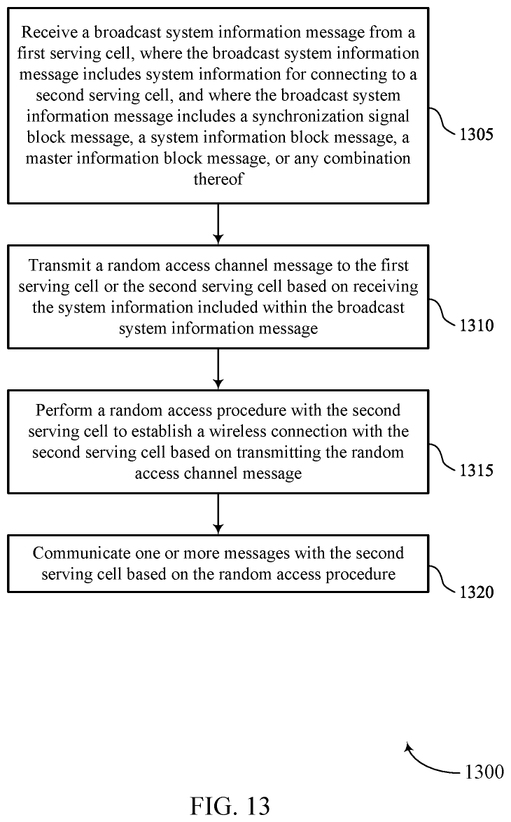

FIG. 13 shows a flowchart illustrating a method 1300 that supports system information for assisted access in wireless communications in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a broadcast SI message from a first serving cell, where the broadcast SI message includes SI for connecting to a second serving cell, and where the broadcast SI message includes an SSB message, a SIB message, a MIB message, or any combination thereof. The operations of block 1305 may be performed in accordance with examples as disclosed herein. In some examples, aspects of the operations of 1305 may be performed by an SI message receiving manager 725 as described with reference to FIG. 7.

At 1310, the method may include transmitting a RACH message to the first serving cell or the second serving cell based on receiving the SI included within the broadcast SI message. The operations of block 1310 may be performed in accordance with examples as disclosed herein. In some examples, aspects of the operations of 1310 may be performed by a RACH message transmitting manager 730 as described with reference to FIG. 7.

At 1315, the method may include performing a random access procedure with the second serving cell to establish a wireless connection with the second serving cell based on transmitting the RACH message. The operations of block 1315 may be performed in accordance with examples as disclosed herein. In some examples, aspects of the operations of 1315 may be performed by a RACH procedure manager 735 as described with reference to FIG. 7.

At 1320, the method may include communicating one or more messages with the second serving cell based on the random access procedure. The operations of block 1320 may be performed in accordance with examples as disclosed herein. In some examples, aspects of the operations of 1320 may be performed by a serving cell manager 740 as described with reference to FIG. 7.

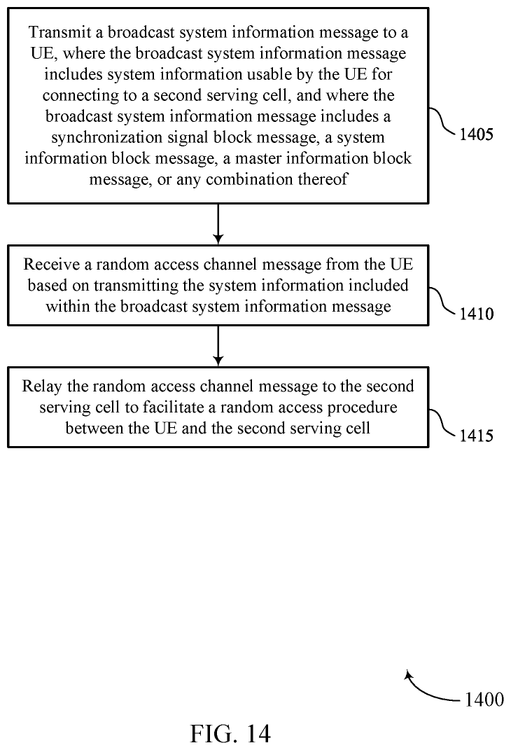

FIG. 14 shows a flowchart illustrating a method 1400 that supports system information for assisted access in wireless communications in accordance with aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a broadcast SI message to a UE, where the broadcast SI message includes SI usable by the UE for connecting to a second serving cell, and where the broadcast SI message includes an SSB message, a SIB message, a MIB message, or any combination thereof. The operations of block 1405 may be performed in accordance with examples as disclosed herein. In some examples, aspects of the operations of 1405 may be performed by an SI message transmitting manager 1125 as described with reference to FIG. 11.

At 1410, the method may include receiving a RACH message from the UE based on transmitting the SI included within the broadcast SI message. The operations of block 1410 may be performed in accordance with examples as disclosed herein. In some examples, aspects of the operations of 1410 may be performed by a RACH message receiving manager 1130 as described with reference to FIG. 11.

At 1415, the method may include relaying the RACH message to the second serving cell to facilitate a random access procedure between the UE and the second serving cell. The operations of block 1415 may be performed in accordance with examples as disclosed herein. In some examples, aspects of the operations of 1415 may be performed by a cell relaying manager 1135 as described with reference to FIG. 11.

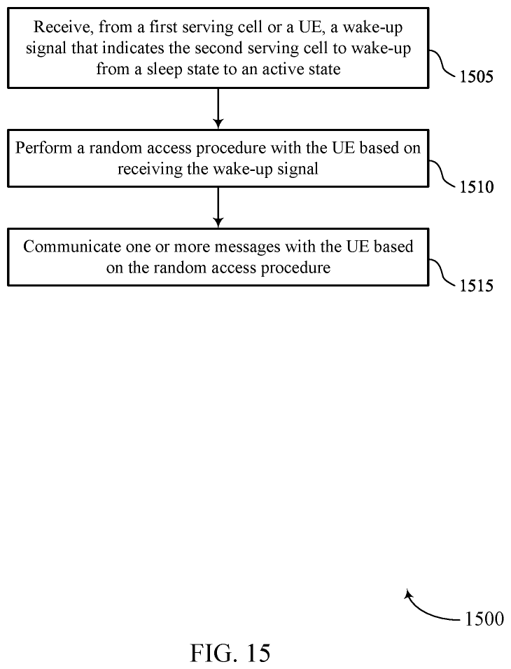

FIG. 15 shows a flowchart illustrating a method 1500 that supports system information for assisted access in wireless communications in accordance with aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a first serving cell or a UE, a wake-up signal that indicates the second serving cell to wake-up from a sleep state to an active state. The operations of block 1505 may be performed in accordance with examples as disclosed herein. In some examples, aspects of the operations of 1505 may be performed by a WUS receiving manager 1140 as described with reference to FIG. 11.

At 1510, the method may include performing a random access procedure with the UE based on receiving the wake-up signal. The operations of block 1510 may be performed in accordance with examples as disclosed herein. In some examples, aspects of the operations of 1510 may be performed by a RACH procedure manager 1145 as described with reference to FIG. 11.

At 1515, the method may include communicating one or more messages with the UE based on the random access procedure. The operations of block 1515 may be performed in accordance with examples as disclosed herein. In some examples, aspects of the operations of 1515 may be performed by a UE communicating manager 1150 as described with reference to FIG. 11.

The following provides an overview of aspects of the present disclosure:

Aspect 1: A method for wireless communications at a UE, comprising: receiving a broadcast SI message from a first serving cell, wherein the broadcast SI message comprises SI for connecting to a second serving cell, and wherein the broadcast SI message comprises an SSB message, a SI block message, a MIB message, or any combination thereof; transmitting a RACH message to the first serving cell or the second serving cell based at least in part on receiving the SI included within the broadcast SI message; performing a random access procedure with the second serving cell to establish a wireless connection with the second serving cell based at least in part on transmitting the RACH message; and communicating one or more messages with the second serving cell based at least in part on the random access procedure.

Aspect 2: The method of aspect 1, wherein the broadcast SI message comprises one or more bit fields that indicate whether the broadcast SI message comprises the SI for connecting to the second serving cell.

Aspect 3: The method of any of aspects 1 through 2, wherein the SI for connecting to the second serving cell comprises one or more RACH sequences for transmitting the RACH message, resources associated with RACH occasions, one or more RAR search space configurations, one or more BWPs for communicating with the second serving cell, a CORESET associated with the second serving cell, or any combination thereof.

Aspect 4: The method of any of aspects 1 through 3, wherein the SI included within the broadcast SI message indicates whether a first set of resources for communicating with the first serving cell are located on a separate component carrier relative to a second set of resources for communicating with the second serving cell, or whether the first set of resources for communicating with the first serving cell are within a same component carrier as the second set of resources for communicating with the second serving cell.

Aspect 5: The method of any of aspects 1 through 4, wherein transmitting the RACH message comprises: transmitting the RACH message to the second serving cell in accordance with the SI included within the broadcast SI message.

Aspect 6: The method of any of aspects 1 through 5, further comprising: receiving a second broadcast SI message from the second serving cell based at least in part on transmitting the RACH message, wherein the second broadcast SI message comprises additional SI for connecting to the second serving cell, wherein the random access procedure is performed with the second serving cell in accordance with the SI and the additional SI.

Aspect 7: The method of aspect 6, wherein transmitting the RACH message comprises: transmitting the RACH message to the second serving cell, wherein the RACH message comprises a wake-up indication for the second serving cell, and wherein the second broadcast SI message is received based at least in part on the wake-up indication.

Aspect 8: The method of any of aspects 6 through 7, wherein transmitting the RACH message comprises: transmitting the RACH message to the first serving cell, wherein the RACH message comprises a wake-up indication for the second serving cell and a request for the first serving cell to relay the RACH message and the wake-up indication to the second serving cell, and wherein the second broadcast SI message received based at least in part on the wake-up indication.

Aspect 9: The method of any of aspects 6 through 8, wherein the second broadcast SI message comprises a SI block message.

Aspect 10: The method of any of aspects 1 through 9, wherein the SI included within the broadcast SI message comprises one or more bit fields associated with a SI block configuration, the one or more bit fields are associated with a first interpretation if the SI block configuration is applied to the first serving cell, and the one or more bit fields are associated with a second interpretation if the SI block configuration is applied to the second serving cell.

Aspect 11: The method of any of aspects 1 through 10, further comprising: receiving one or more SSB messages from the second serving cell based at least in part on transmitting the RACH message, wherein performing the random access procedure is based at least in part on receiving the one or more SSB messages.

Aspect 12: The method of any of aspects 1 through 11, wherein the first serving cell and the second serving cell are supported by a same network entity.

Aspect 13: The method of any of aspects 1 through 12, wherein the first serving cell is associated with a first RAT, and the second serving cell is associated with a second RAT.

Aspect 14: The method of aspect 13, wherein the first RAT comprises a 5G RAT, a New Radio access technology, or both, and the second RAT comprises a 6G RAT.

Aspect 15: A method for wireless communications at a first serving cell, comprising: transmitting a broadcast SI message to a UE, wherein the broadcast SI message comprises SI usable by the UE for connecting to a second serving cell, and wherein the broadcast SI message comprises an SSB message, a SI block message, a MIB message, or any combination thereof; receiving a RACH message from the UE based at least in part on transmitting the SI included within the broadcast SI message; and relaying the RACH message to the second serving cell to facilitate a random access procedure between the UE and the second serving cell.

Aspect 16: The method of aspect 15, wherein the broadcast SI message comprises one or more bit fields that indicate whether the broadcast SI message comprises the SI for connecting to the second serving cell.

Aspect 17: The method of any of aspects 15 through 16, wherein the SI for connecting to the second serving cell comprises one or more RACH sequences for transmitting the RACH message, resources associated with RACH occasions, one or more RAR search space configurations, one or more BWPs for communicating with the second serving cell, a CORESET associated with the second serving cell, or any combination thereof.

Aspect 18: The method of any of aspects 15 through 17, wherein the SI included within the broadcast SI message indicates whether a first set of resources for communicating with the first serving cell are located on a separate component carrier relative to a second set of resources for communicating with the second serving cell, or whether the first set of resources for communicating with the first serving cell are within a same component carrier as the second set of resources for communicating with the second serving cell.

Aspect 19: The method of any of aspects 15 through 18, wherein the RACH message comprises a wake-up indication for the second serving cell and a request for the first serving cell to relay the RACH message and the wake-up indication to the second serving cell, and relaying the RACH message is based at least in part on receiving the wake-up indication and the request.

Aspect 20: The method of any of aspects 15 through 19, wherein the SI included within the broadcast SI message comprises one or more bit fields associated with a SI block configuration, the one or more bit fields are associated with a first interpretation if the SI block configuration is applied to the first serving cell, and the one or more bit fields are associated with a second interpretation if the SI block configuration is applied to the second serving cell.

Aspect 21: The method of any of aspects 15 through 20, wherein relaying the RACH message comprises: relaying the RACH message to a plurality of additional serving cells including the second serving cell.

Aspect 22: The method of any of aspects 15 through 21, wherein the first serving cell and the second serving cell are supported by a same network entity.

Aspect 23: The method of any of aspects 15 through 22, wherein the first serving cell is associated with a first RAT, and the second serving cell is associated with a second RAT.

Aspect 24: The method of aspect 23, wherein the first RAT comprises a 5G RAT, a New Radio access technology, or both, and the second RAT comprises a 6G RAT.

Aspect 25: A method for wireless communication at a second serving cell, comprising: receiving, from a first serving cell or a UE, a wake-up signal that indicates the second serving cell to wake-up from a sleep state to an active state; performing a random access procedure with the UE based at least in part on receiving the wake-up signal; and communicating one or more messages with the UE based at least in part on the random access procedure.

Aspect 26: The method of aspect 25, further comprising: transmitting a SI message to the UE based at least in part on receiving the wake-up signal, wherein the SI message comprises SI usable by the UE for connecting with the second serving cell.

Aspect 27: The method of any of aspects 25 through 26, further comprising: receiving a RACH message from the UE, wherein the wake-up signal is received via the RACH message, and wherein performing the random access procedure is based at least in part on receiving the RACH message.

Aspect 28: The method of any of aspects 25 through 27, further comprising: receiving, from the first serving cell, a RACH message relayed associated with the UE, wherein the wake-up signal is received via the RACH message, and wherein performing the random access procedure is based at least in part on receiving the RACH message.

Aspect 29: A UE comprising one or more memories storing processor-executable code, and one or more processors coupled with the one or more memories and individually or collectively operable to execute the code to cause the UE to perform a method of any of aspects 1 through 14.

Aspect 30: A UE comprising at least one means for performing a method of any of aspects 1 through 14.

Aspect 31: A non-transitory computer-readable medium storing code the code comprising instructions executable by a processor to perform a method of any of aspects 1 through 14.

Aspect 32: A network entity associated with a first serving cell for wireless communications, the network entity comprising one or more memories storing processor-executable code, and one or more processors coupled with the one or more memories and individually or collectively operable to execute the code to cause the network entity to, via the first serving cell, perform a method of any of aspects 15 through 24.

Aspect 33: A network entity associated with a first serving cell for wireless communications, the network entity comprising at least one means for performing a method of any of aspects 15 through 24.

Aspect 34: A non-transitory computer-readable medium storing code the code comprising instructions executable by a processor to perform a method of any of aspects 15 through 24.

Aspect 35: A network entity associated with a second serving cell for wireless communications, the network entity comprising one or more memories storing processor-executable code, and one or more processors coupled with the one or more memories and individually or collectively operable to execute the code to cause the network entity to, via the second serving cell, perform a method of any of aspects 25 through 28.

Aspect 36: A network entity associated with a second serving cell for wireless communications, the network entity comprising at least one means for performing a method of any of aspects 25 through 28.

Aspect 37: A non-transitory computer-readable medium storing code the code comprising instructions executable by a processor to perform a method of any of aspects 25 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a broadcast system information message from a first serving cell, wherein the broadcast system information message comprises system information for connecting to a second serving cell, and wherein the broadcast system information message comprises a synchronization signal block message, a system information block message, a master information block message, or any combination thereof;
transmit a random access channel message to the first serving cell or the second serving cell based at least in part on receiving the system information included within the broadcast system information message;
perform a random access procedure with the second serving cell to establish a wireless connection with the second serving cell based at least in part on transmitting the random access channel message; and
communicate one or more messages with the second serving cell based at least in part on the random access procedure.

2. The UE of claim 1, wherein the broadcast system information message comprises one or more bit fields that indicate whether the broadcast system information message comprises the system information for connecting to the second serving cell.

3. The UE of claim 1, wherein the system information for connecting to the second serving cell comprises one or more random access channel sequences for transmitting the random access channel message, resources associated with random access channel occasions, one or more random access response search space configurations, one or more bandwidth parts for communicating with the second serving cell, a control resource set associated with the second serving cell, or any combination thereof.

4. The UE of claim 1, wherein the system information included within the broadcast system information message indicates whether a first set of resources for communicating with the first serving cell are located on a separate component carrier relative to a second set of resources for communicating with the second serving cell, or whether the first set of resources for communicating with the first serving cell are within a same component carrier as the second set of resources for communicating with the second serving cell.

5. The UE of claim 1, wherein, to transmit the random access channel message, the one or more processors are individually or collectively operable to execute the code to cause the UE to:
transmit the random access channel message to the second serving cell in accordance with the system information included within the broadcast system information message.

6. The UE of claim 1, wherein the one or more processors are individually or collectively further operable to execute the code to cause the UE to:
receive a second broadcast system information message from the second serving cell based at least in part on transmitting the random access channel message, wherein the second broadcast system information message comprises additional system information for connecting to the second serving cell, wherein the random access procedure is performed with the second serving cell in accordance with the system information and the additional system information.

7. The UE of claim 6, wherein, to transmit the random access channel message, the one or more processors are individually or collectively operable to execute the code to cause the UE to:
transmit the random access channel message to the second serving cell, wherein the random access channel message comprises a wake-up indication for the second serving cell, and wherein the second broadcast system information message is received based at least in part on the wake-up indication.

8. The UE of claim 6, wherein, to transmit the random access channel message, the one or more processors are individually or collectively operable to execute the code to cause the UE to:
transmit the random access channel message to the first serving cell, wherein the random access channel message comprises a wake-up indication for the second serving cell and a request for the first serving cell to relay the random access channel message and the wake-up indication to the second serving cell, and wherein the second broadcast system information message received based at least in part on the wake-up indication.

9. The UE of claim 6, wherein the second broadcast system information message comprises a system information block message.

10. The UE of claim 1, wherein the system information included within the broadcast system information message comprises one or more bit fields associated with a system information block configuration, wherein the one or more bit fields are associated with a first interpretation if the system information block configuration is applied to the first serving cell, and wherein the one or more bit fields are associated with a second interpretation if the system information block configuration is applied to the second serving cell.

11. The UE of claim 1, wherein the one or more processors are individually or collectively further operable to execute the code to cause the UE to:
receive one or more synchronization signal block messages from the second serving cell based at least in part on transmitting the random access channel message, wherein performing the random access procedure is based at least in part on receiving the one or more synchronization signal block messages.

12. The UE of claim 1, wherein the first serving cell and the second serving cell are supported by a same network entity.

13. The UE of claim 1, wherein the first serving cell is associated with a first radio access technology, and wherein the second serving cell is associated with a second radio access technology.

14. The UE of claim 13, wherein the first radio access technology comprises a Fifth Generation radio access technology, a New Radio access technology, or both, and wherein the second radio access technology comprises a Sixth Generation radio access technology.

15. A network entity associated with a first serving cell, the network entity comprising:
one or more memories storing processor-executable code; and
one or more processors coupled with the one or more memories and individually or collectively operable to execute the code to cause the network entity to, via the first serving cell:
transmit a broadcast system information message to a user equipment (UE), wherein the broadcast system information message comprises system information usable by the UE for connecting to a second serving cell, and wherein the broadcast system information message comprises a synchronization signal block message, a system information block message, a master information block message, or any combination thereof;
receive a random access channel message from the UE based at least in part on transmitting the system information included within the broadcast system information message; and
relay the random access channel message to the second serving cell to facilitate a random access procedure between the UE and the second serving cell.

16. The network entity of claim 15, wherein the broadcast system information message comprises one or more bit fields that indicate whether the broadcast system information message comprises the system information for connecting to the second serving cell.

17. The network entity of claim 15, wherein the system information for connecting to the second serving cell comprises one or more random access channel sequences for transmitting the random access channel message, resources associated with random access channel occasions, one or more random access response search space configurations, one or more bandwidth parts for communicating with the second serving cell, a control resource set associated with the second serving cell, or any combination thereof.

18. The network entity of claim 15, wherein the system information included within the broadcast system information message indicates whether a first set of resources for communicating with the first serving cell are located on a separate component carrier relative to a second set of resources for communicating with the second serving cell, or whether the first set of resources for communicating with the first serving cell are within a same component carrier as the second set of resources for communicating with the second serving cell.

19. The network entity of claim 15, wherein the random access channel message comprises a wake-up indication for the second serving cell and a request for the first serving cell to relay the random access channel message and the wake-up indication to the second serving cell, and wherein relaying the random access channel message is based at least in part on receiving the wake-up indication and the request.

20. The network entity of claim 15, wherein the system information included within the broadcast system information message comprises one or more bit fields associated with a system information block configuration, wherein the one or more bit fields are associated with a first interpretation if the system information block configuration is applied to the first serving cell, and wherein the one or more bit fields are associated with a second interpretation if the system information block configuration is applied to the second serving cell.

21. The network entity of claim 15, wherein, to relay the random access channel message, the one or more processors are individually or collectively operable to execute the code to cause the network entity to, via the first serving cell:
relay the random access channel message to a plurality of additional serving cells including the second serving cell.

22. The network entity of claim 15, wherein the first serving cell and the second serving cell are both supported by the network entity.

23. The network entity of claim 15, wherein the first serving cell is associated with a first radio access technology, and wherein the second serving cell is associated with a second radio access technology.

24. The network entity of claim 23, wherein the first radio access technology comprises a Fifth Generation radio access technology, a New Radio access technology, or both, and wherein the second radio access technology comprises a Sixth Generation radio access technology.

25. A network entity associated with a second serving cell, the network entity comprising:
one or more memories storing processor-executable code; and
one or more processors coupled with the one or more memories and individually or collectively operable to execute the code to cause the network entity to, via the second serving cell:
receive, from a first serving cell or a user equipment (UE), a wake-up signal that indicates the second serving cell to wake-up from a sleep state to an active state;
perform a random access procedure with the UE based at least in part on receiving the wake-up signal; and
communicate one or more messages with the UE based at least in part on the random access procedure.

26. The network entity of claim 25, wherein the one or more processors are individually or collectively further operable to execute the code to cause the network entity to, via the second serving cell:
transmit a system information message to the UE based at least in part on receiving the wake-up signal, wherein the system information message comprises system information usable by the UE for connecting with the second serving cell.

27. The network entity of claim 25, wherein the one or more processors are individually or collectively further operable to execute the code to cause the network entity to, via the second serving cell:
receive a random access channel message from the UE, wherein the wake-up signal is received via the random access channel message, and wherein performing the random access procedure is based at least in part on receiving the random access channel message.

28. The network entity of claim 25, wherein the one or more processors are individually or collectively further operable to execute the code to cause the network entity to, via the second serving cell:
receive, from the first serving cell, a random access channel message relayed associated with the UE, wherein the wake-up signal is received via the random access channel message, and wherein performing the random access procedure is based at least in part on receiving the random access channel message.

29. A method for wireless communications at a user equipment (UE), comprising:
receiving a broadcast system information message from a first serving cell, wherein the broadcast system information message comprises system information for connecting to a second serving cell, and wherein the broadcast system information message comprises a synchronization signal block message, a system information block message, a master information block message, or any combination thereof;
transmitting a random access channel message to the first serving cell or the second serving cell based at least in part on receiving the system information included within the broadcast system information message;
performing a random access procedure with the second serving cell to establish a wireless connection with the second serving cell based at least in part on transmitting the random access channel message; and
communicating one or more messages with the second serving cell based at least in part on the random access procedure.

30. The method of claim 29, wherein the broadcast system information message comprises one or more bit fields that indicate whether the broadcast system information message comprises the system information for connecting to the second serving cell.
